(19) United States
(12) Patent Application Publication
(10) Pub. No.: US 2011/0273770 A1
(43) Pub. Date: Nov. 10, 2011

(54) COLOR COMBINER

(76) Inventors: Yarn Chee Poon, Singapore (SG); Andrew J. Ouderkirk, Singapore (SG); Philip E. Watson, Singapore (SG); Kim L. Tan, Singapore (SG); Xiaohui Cheng, Singapore (SG)

(21) Appl. No.: 13/129,888

(22) PCT Filed: Nov. 18, 2009
(86) PCT No.: PCT/US09/64927

§ 371 Date: Jul. 29, 2011

Related U.S. Application Data
(60) Provisional application No. 61/116,072, filed on Nov. 19, 2008.
(60) Provisional application No. 61/116,061, filed on Nov. 19, 2008.

(51) Int. Cl. G02B 27/10; G02B 27/28

(52) U.S. Cl. 359/485.03

(57) ABSTRACT

Optical elements, color combiners using the optical elements, and image projectors using the color combiners are described. The optical elements can be configured as color combiners that receive different wavelength spectrums of light and produce a combined light output that includes the different wavelength spectrums of light. In one aspect, the received light inputs are unpolarized, and the combined light output is polarized in a desired state. In one aspect, the received light inputs are unpolarized, and the combined light output is also unpolarized. The optical elements are configured to minimize the passage of light which may be damaging to wave-length-sensitive components in the light combiner. Image projectors using the color combiners can include imaging modules that operate by reflecting or transmitting polarized light.

### BACKGROUND

Projection systems used for projecting an image on a screen can use multiple color light sources, such as light emitting diodes (LED's), with different colors to generate the illumination light. Several optical elements are disposed between the LED's and the image display unit to combine and transfer the light from the LED's to the image display unit. The image display unit can use various methods to impose an image on the light. For example, the image display unit may use polarization, as with transmissive or reflective liquid crystal displays.

Still other projection systems used for projecting an image on a screen can use white light configured to imagewise reflect from a digital micro-mirror array, such as the array used in Texas Instruments' Digital Light Processor (DLP®) displays. In the DLP® display, individual mirrors within the digital micro-mirror array represent individual pixels of the projected image. A display pixel is illuminated when the corresponding mirror is tilted so that incident light is directed into the projected optical path. A rotating color wheel placed within the optical path is timed to the reflection of light from the digital micro-mirror array, so that the reflected white light is filtered to project the color corresponding to the pixel. The digital micro-mirror array is then switched to the next desired pixel color, and the process is continued at such a rapid rate that the entire projected display appears to be continuously illuminated. The digital micro-mirror projection system requires fewer pixelated array components, which can result in a smaller size projector.

Image brightness is an important parameter of a projection system. The brightness of color light sources and the efficiencies of collecting, combining, homogenizing and delivering the light to the image display unit all affect brightness. As the size of modern projector systems decreases, there is a need to maintain an adequate level of output brightness while at the same time keeping heat produced by the color light sources at a low level that can be dissipated in a small projector system. There is a need for a light combining system that combines multiple color lights with increased efficiency to provide a light output with an adequate level of brightness without excessive power consumption by light sources.

### SUMMARY

Generally, the present description relates to optical elements, color combiners using the optical elements, and image projectors using the color combiners. In one aspect, the present disclosure provides an optical element that includes a first color-selective dichroic filter having a first input surface disposed to transmit a first light beam perpendicular to the first input surface, and a second color-selective dichroic filter having a second input surface disposed to transmit a second light beam perpendicular to the second input surface. The optical element further includes a reflective polarizer laminate having a reflective polarizer disposed between a first retarder and a second retarder, wherein the reflective polarizer is disposed to intercept the first light beam and the second light beam at an angle of approximately 45 degrees so that the first and the second light beam are combined into a combined elliptical polarized light. In yet another aspect, the present disclosure provides a color combiner including the optical element. In yet another aspect, the present disclosure provides a display system including an imaging panel and the color combiner.

In another aspect, the present disclosure provides an optical element that includes a first color-selective dichroic filter having a first input surface disposed to transmit a first light beam perpendicular to the first input surface, and a second color-selective dichroic filter having a second input surface disposed to transmit a second light beam perpendicular to the second input surface. The optical element further includes a first reflective polarizer laminate having a first reflective polarizer disposed between a first retarder and a second retarder, wherein the first reflective polarizer is disposed to intercept the first light beam and the second light beam at an angle of approximately 45 degrees; and a second reflective polarizer laminate having a second reflective polarizer disposed between a third retarder and a fourth retarder, wherein the second reflective polarizer is disposed to intercept a reflected first and second light beam from the first reflective polarizer laminate at an angle of approximately 45 degrees. The optical element still further includes a first reflector disposed so that a line normal to the first reflector intercepts the first reflective polarizer at an angle of approximately 45 degrees, and a second reflector disposed so that a line normal to the second reflector intercepts the second reflective polarizer at an angle of approximately 45 degrees, wherein the first and second reflective polarizer laminates and the first and second reflectors cooperate so that the first and the second light beam are combined into a combined elliptical polarized light. In yet another aspect, the present disclosure provides a color combiner including the optical element. In yet another aspect, the present disclosure provides a display system including an imaging panel and the color combiner.

In yet another aspect, the present disclosure provides an optical element that includes a first color-selective dichroic filter having a first input surface disposed to transmit a first light beam perpendicular to the first input surface, and a second color-selective dichroic filter having a second input surface disposed to transmit a second light beam perpendicular to the second input surface. The optical element further includes a first reflective polarizer laminate having a first reflective polarizer disposed between a first retarder and a second retarder, wherein the first reflective polarizer is disposed to intercept the first light beam at an angle of approximately 45 degrees; and a second reflective polarizer laminate having a second reflective polarizer disposed between a third retarder and a fourth retarder, wherein the second reflective polarizer is disposed to intercept the second light beam from the first reflective polarizer laminate at an angle of approximately 45 degrees. The optical element still further includes a first reflector disposed so that a line normal to the first reflector intercepts the first reflective polarizer at an angle of approximately 45 degrees, and a second reflector disposed so that a line normal to the second reflector intercepts the second reflective polarizer at an angle of approximately 45 degrees, wherein the first and second reflective polarizer laminates and the first and second reflectors cooperate so that the first and the second light beam are combined into a combined elliptical polarized light. In yet another aspect, the present disclosure provides a color combiner including the optical element. In yet another aspect, the present disclosure provides a display system including an imaging panel and the color combiner.

In yet another aspect, the present disclosure provides an optical element that includes a first color-selective dichroic filter having a first input surface disposed to transmit a first light beam perpendicular to the first input surface, and a second color-selective dichroic filter having a second input surface disposed to transmit a second light beam perpendicular to the second input surface. The optical element further includes a first reflective polarizer laminate having a first reflective polarizer disposed adjacent to a first retarder, wherein the first retarder is disposed to intercept the first light beam and the second light beam at an angle of approximately 45 degrees, and a second reflective polarizer laminate having a second reflective polarizer disposed adjacent to a second retarder, wherein the second retarder is disposed to intercept a reflected first and second light beam from the first reflective polarizer laminate at an angle of approximately 45 degrees. The optical element still further includes a half-wave retarder disposed between the first retarder and the second retarder, wherein the first and second reflective polarizer laminates and the half-wave retarder cooperate so that the first and the second light beam are combined into a combined linear polarized light having a first polarization state. In yet another aspect, the present disclosure provides a color combiner including the optical element. In yet another aspect, the present disclosure provides a display system including an imaging panel and the color combiner.

In yet another aspect, the present disclosure provides an optical element that includes a first color-selective dichroic filter having a first input surface disposed to transmit a first light beam perpendicular to the first input surface, and a second color-selective dichroic filter having a second input surface disposed to transmit a second light beam perpendicular to the second input surface. The optical element further includes a first reflective polarizer laminate having a first reflective polarizer disposed adjacent to a first retarder, wherein the first retarder is disposed to intercept the first light beam at an angle of approximately 45 degrees; and a second reflective polarizer laminate having a second reflective polarizer disposed adjacent to a second retarder, wherein the second retarder is disposed to intercept the second light beam at an angle of approximately 45 degrees. The optical element still further includes a half-wave retarder disposed between the first retarder and the second retarder, wherein the first and second reflective polarizer laminates and the half-wave retarder cooperate so that the first and the second light beam are combined into a combined linear polarized light having a first polarization state. In yet another aspect, the present disclosure provides a color combiner including the optical element. In yet another aspect, the present disclosure provides a display system including an imaging panel and the color combiner.

In yet another aspect, the present disclosure provides an optical element that includes a first color-selective dichroic filter having a first input surface disposed to transmit a first light beam perpendicular to the first input surface, and a second color-selective dichroic filter having a second input surface disposed to transmit a second light beam perpendicular to the second input surface. The optical element further includes a first reflective polarizer laminate having a first reflective polarizer disposed adjacent a first retarder, wherein the first retarder is disposed to intercept the first light beam and the second light beam at an angle of approximately 45 degrees; and a second reflective polarizer laminate having a second reflective polarizer disposed adjacent to a second retarder, wherein the second retarder is disposed to intercept a transmitted first light beam and second light beam from the first reflective polarizer laminate at an angle of approximately 45 degrees. The optical element still further includes a reflector disposed so that a line normal to the reflector intercepts the second reflective polarizer at an angle of approximately 45 degrees, wherein the first and second reflective polarizer laminates and the reflector cooperate so that the first and the second light beam are combined into a combined linear polarized light having a first polarization state. In yet another aspect, the present disclosure provides a color combiner including the optical element. In yet another aspect, the present disclosure provides a display system including an imaging panel and the color combiner.

In yet another aspect, the present disclosure provides an optical element that includes a first color-selective dichroic filter having a first input surface disposed to transmit a first light beam perpendicular to the first input surface, and a second color-selective dichroic filter having a second input surface disposed to transmit a second light beam perpendicular to the second input surface. The optical element further includes a first reflective polarizer laminate having a first reflective polarizer disposed adjacent a first retarder, wherein the first retarder is disposed to intercept the first light beam and the second light beam at an angle of approximately 45 degrees; and a second reflective polarizer laminate having a second reflective polarizer disposed adjacent to a second retarder, wherein the second retarder is disposed to intercept a second light beam at an angle of approximately 45 degrees. The optical element still further includes a reflector disposed so that a line normal to the reflector intercepts the second reflective polarizer at an angle of approximately 45 degrees, wherein the first and second reflective polarizer laminates and the reflector cooperate so that the first and the second light beam are combined into a combined linear polarized light having a first polarization state. In yet another aspect, the present disclosure provides a color combiner including the optical element. In yet another aspect, the present disclosure provides a display system including an imaging panel and the color combiner.

In yet another aspect, the present disclosure provides an optical element that includes a first color-selective dichroic filter having a first input surface disposed to transmit a first light beam perpendicular to the first input surface, and a second color-selective dichroic filter having a second input surface disposed to transmit a second light beam perpendicular to the second input surface. The optical element further includes a first reflective polarizer laminate having a first reflective polarizer disposed adjacent to a first retarder, wherein the first retarder is disposed to intercept the first light beam and the second light beam at an angle of approximately 45 degrees; and a second reflective polarizer laminate having a second reflective polarizer disposed adjacent a second retarder, wherein the second reflective polarizer is disposed to intercept a transmitted first linear polarization state of the first and the second third light beams at an angle of approximately 45 degrees. The optical element still further includes a first reflector disposed so that a line normal to the first reflector intercepts the second reflective polarizer laminate at an angle of approximately 45 degrees, and a second reflector disposed so that a line normal to the second reflector intercepts the second reflective polarizer laminate at an angle of approximately 45 degrees, wherein the first and second reflective polarizer laminates and the first and second reflectors cooperate so that the first and the second light beams are combined into a combined linear polarized light having the first polarization state. In yet another aspect, the present disclosure provides a color combiner including the optical element. In yet another aspect, the present disclosure provides a display system including an imaging panel and the color combiner. In yet another aspect, the present disclosure provides an optical element that includes a first color-selective dichroic filter having a first input surface disposed to transmit a first light beam perpendicular to the first input surface, and a second color-selective dichroic filter having a second input surface disposed to transmit a second light beam perpendicular to the second input surface. The optical element further includes a first reflective polarizer laminate having a first reflective polarizer disposed adjacent to a first retarder, wherein the first retarder is disposed to intercept the first light beam and the second light beam at an angle of approximately 45 degrees; and a second reflective polarizer laminate having a second reflective polarizer disposed adjacent a second retarder, wherein the second reflective polarizer is disposed to intercept a transmitted first linear polarization state of the first beam at an angle of approximately 45 degrees. The optical element still further includes a first reflector disposed so that a line normal to the first reflector intercepts the second reflective polarizer laminate at an angle of approximately 45 degrees, and a second reflector disposed so that a line normal to the second reflector intercepts the second reflective polarizer laminate at an angle of approximately 45 degrees, wherein the first and second reflective polarizer laminates and the first and second reflectors cooperate so that the first and the second light beams are combined into a combined linear polarized light having the first polarization state. In yet another aspect, the present disclosure provides a color combiner including the optical element. In yet another aspect, the present disclosure provides a display system including an imaging panel and the color combiner.

These and other aspects of the present application will be apparent from the detailed description below. In no event, however, should the above summaries be construed as limitations on the claimed subject matter, which subject matter is defined solely by the attached claims, as may be amended during prosecution.

### BRIEF DESCRIPTION OF THE DRAWINGS

Throughout the specification reference is made to the appended drawings, where like reference numerals designate like elements, and wherein:

FIG. 1 is a perspective view of a polarizing beam splitter;

FIG. 2 is a perspective view of a polarizing beam splitter with a quarter-wave retarder;

FIG. 3 is a top schematic view of a polarizing beam splitter with polished faces;

FIG. 4 is a perspective view of a polarizing beam splitter;

FIG. 5 is a cross-sectional schematic of a reflective polarizer laminate;

FIG. 6 is a top schematic view of a color combiner;

FIG. 7 is a top schematic view of a color combiner;

FIG. 8 is a top schematic view of a color combiner;

FIG. 9 is a top schematic view of a color combiner;

FIG. 10 is a top schematic view of a color combiner;

FIG. 11 is a top schematic view of a color combiner;

FIGS. 12A-12H are schematic views of a process; and

FIG. 13 is a schematic view of a projector.

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

Typical color combiners include a quarter-wave retarder film that is sandwiched between a prism surface and a dichroic coating, for each individual color input to the color combiner. The quarter-wave retarder is separately prepared from birefringent materials, and can be unsuitable for direct coating of a high precision dichroic layer. As a result, each of the dichroic coatings has to be prepared on a separate substrate, and the dichroic coated substrate is mounted to the prism face by lamination. These additional components and processing steps can add considerable costs to the color combiner assembly.

In one aspect, the present disclosure reduces the number of components needed to fabricate a color combiner (CC). The quarter-wave films are removed from the surfaces of the CC cube into the diagonal plane. This allows for the dichroic coatings to be directly applied to the prism substrates, making up the CC cube. Further, the three separate quarter films have been reduced to two films, by lamination on both sides of the reflective polarizer located at the diagonal plane. The output polarization of the CC system is also circularized, rendering more brightness uniformity as the subsequent optics does not deal with individual s-polarization and p-polarization; instead, both s-polarization and p-polarizations are present to a similar degree, i.e. either as elliptical or circular polarization states.

In one particular embodiment, the combined color combiner described herein can significantly reduce fabrication costs, for example, due to reduced number of components needed and a simplified assembly procedure. In some cases, an automation machine could perform steps such as pick and place of the reflective polarizers and quarter-wave retarders onto prisms, and dispensing of an optical adhesive between the layers. In some cases, the quarter-wave retarder/polarizing/quarter-wave retarder stack could be laminated together first, before it is disposed between the CC prisms with optical adhesives.

The optical elements described herein can be configured as color combiners that receive different wavelength spectrum lights and produce a combined light output that includes the different wavelength spectrum lights. In one aspect, the received light inputs are unpolarized, and the combined light output is polarized in a desired state. In one embodiment, received lights with the undesired polarization state are recycled and rotated to the desired polarization state, improving the light utilization efficiency. The combined light can be a polychromatic combined light that comprises more than one wavelength spectrum of light. The combined light can be a time sequenced output of each of the received lights. In one aspect, each of the different wavelength spectra of light corresponds to a different color light (e.g. red, green and blue), and the combined light output is white light, or a time sequenced red, green and blue light. For purposes of the description provided herein, “color light” and “wavelength spectrum light” are both intended to mean light having a wavelength spectrum range which may be correlated to a specific color if visible to the human eye. The more general term “wavelength spectrum light” refers to both visible and other wavelength spectrums of light including, for example, infrared light.

Also for the purposes of the description provided herein, the term “aligned to a desired polarization state” is intended to associate the alignment of the pass axis of an optical element to a desired polarization state of light that passes through the optical element, i.e., a desired polarization state such as s-polarization, p-polarization, right-circular polarization, left-circular polarization, or the like. In one embodiment described herein with reference to the Figures, an optical element such as a polarizer aligned to the first polarization state means the orientation of the polarizer that passes the p-polarization state of light, and reflects or absorbs the second polarization state (in this case the s-polarization state) of light. It is to be understood that the polarizer can instead be aligned to pass the s-polarization state of light, and reflect or absorb the p-polarization state of light, if desired.

Also for the purposes of the description provided herein, the term “facing” refers to one element disposed so that a perpendicular line from the surface of the element follows an optical path that is also perpendicular to the other element. One element facing another element can include the elements disposed adjacent each other. One element facing another element further includes the elements separated by optics so that a light ray perpendicular to one element is also perpendicular to the other element.

When two or more unpolarized color lights are directed to the optical element, each may be split according to polarization by one or more reflective polarizers. According to one embodiment described below, a color light combining system receives unpolarized light from different color unpolarized light sources, and produces a combined light output that is polarized in one desired state. In one aspect, two, three, four, or more received color lights are each split according to polarization (e.g. s-polarization and p-polarization, or right and left circular polarization) by a reflective polarizer in the optical element. The received light of one polarization state is recycled to become the desired polarization state.

According to one aspect, the optical element comprises a reflective polarizer positioned so that light from each of the three color lights intercept the reflective polarizer at approximately a 45 degree angle. The reflective polarizer can be any known reflective polarizer such as a MacNeille polarizer, a wire grid polarizer, a multilayer optical film polarizer, or a circular polarizer such as a cholesteric liquid crystal polarizer. According to one embodiment, a multilayer optical film polarizer can be a preferred reflective polarizer.

Multilayer optical film polarizers can include different “packets” of layers that serve to interact with different wavelength ranges of light. For example, a unitary multilayer optical film polarizer can include several packets of layers through the film thickness, each packet interacting with a different wavelength range (e.g. color) of light to reflect one polarization state and transmit the other polarization state. In one aspect, a multilayer optical film can have a first packet of layers adjacent a first surface of the film that interacts with, for example, blue colored light (i.e., a “blue layers”), a second packet of layers that interacts with, for example, green colored light (i.e., a “green layers”), and a third packet of layers adjacent a second surface of the film that interacts with, for example, red colored light (i.e. a “red layers”). Typically, the separation between layers in the “blue layers” is much smaller than the separation between layers in the “red layers”, in order to interact with the shorter (and higher energy) blue wavelengths of light.

Polymeric multilayer optical film polarizers can be particularly preferred reflective polarizers that can include packets of film layers as described above. Often, the higher energy wavelengths of light, such as blue light, can adversely affect the aging stability of the film, and at least for this reason it is preferable to minimize the number of interactions of blue light with the reflective polarizer. In addition, the nature of the interaction of blue light with the film affects the severity of the adverse aging. Transmission of blue light through the film is generally less detrimental to the film than reflection of blue light entering from the “blue layers” (i.e. thin layers) side. Also, reflection of blue light entering the film from the “blue layers” side is less detrimental to the film than reflection of blue light entering from the “red layers” (i.e., thick layers) side.

The reflective polarizer can be disposed between the diagonal faces of two prisms, or it can be a free-standing film such as a pellicle. In some embodiments, the optical element light utilization efficiency is improved when the reflective polarizer is disposed between two prisms, e.g. a polarizing beam splitter (PBS). In this embodiment, some of the light traveling through the PBS that would otherwise be lost from the optical path can undergo Total Internal Reflection (TIR) from the prism faces and rejoin the optical path. For at least this reason, the following description is directed to optical elements where reflective polarizers are disposed between the diagonal faces of two prisms; however, it is to be understood that the PBS can function in the same manner when used as a pellicle. In one aspect, all of the external faces of the PBS prisms are highly polished so that light entering the PBS undergoes TIR. In this manner, light is contained within the PBS and the light is partially homogenized.

According to one aspect, wavelength selective filters such as color-selective dichroic filters are placed in the path of input light from each of the different colored light sources. Each of the color-selective dichroic filters is positioned so that an input light beam intercepts the filter at near-normal incidence to minimize splitting of s- and p-polarized light, and also to minimize color shifting. Each of the color-selective dichroic filters is selected to transmit light having a wavelength spectrum of the adjacent input light source, and reflect light having a wavelength spectrum of at least one of the other input light sources. In some embodiments, each of the color-selective dichroic filters is selected to transmit light having a wavelength spectrum of the adjacent input light source, and reflect light having a wavelength spectrum of all of the other input light sources. In one aspect, each of the color-selective dichroic filters is positioned relative to the reflective polarizer so that the near-normal input light beam to the surface of each color-selective dichroic filter intersects the reflective polarizer at an intercept angle of approximately 45 degrees. By normal to the surface of a color-selective dichroic filter is meant a line passing perpendicular to the surface the color-selective dichroic filter; by near-normal is meant varying less than about 20 degrees from normal, or preferably less than about 10 degrees from normal. In one embodiment, the intercept angle with the reflective polarizer ranges from about 25 to 65 degrees; from 35 to 55 degrees; from 40 to 50 degrees; from 43 to 47 degrees; or from 44.5 to 45.5 degrees.

In one aspect, input light of an undesired polarization state is converted to the desired polarization state by being directed toward a retarder and a color-selective dichroic filter where it reflects and changes polarization state by passing through the retarder twice. In one embodiment, a retarder is disposed within the light path from each input light to the prism face, so that light from one light source passes through a color-selective dichroic filter and a retarder before entering the PBS prism face. Light having an undesired polarization state is converted by passing through at least a second retarder twice, before and after reflection from at least a second color-selective dichroic filter, changing to the desired polarization state.

In one embodiment, the retarder is placed between the color-selective dichroic filter and the reflective polarizer. The particular combination of color-selective dichroic filters, retarders, and source orientation all cooperate to enable a smaller, more compact, optical element that, when configured as a color combiner, efficiently produces combined light of a single polarization state. According to one aspect, the retarder is a quarter-wave retarder aligned at approximately 45 degrees to a polarization state of the reflective polarizer. In one embodiment, the alignment can be from 30 to 60 degrees; from 40 to 50 degrees; from 43 to 47 degrees; or from 44.5 to 45.5 degrees to a polarization state of the reflective polarizer.

In one aspect, the first color light comprises an unpolarized blue light, the second color light comprises an unpolarized green light and the third color light comprises an unpolarized red light, and the color light combiner combines the red light, blue light and green light to produce polarized white light. In one aspect, the first color light comprises an unpolarized blue light, the second color light comprises an unpolarized green light and the third color light comprises an unpolarized red light, and the color light combiner combines the red, green and blue light to produce a time sequenced polarized red, green and blue light. In one aspect, each of the first, second and third color lights are disposed in separate light sources. In another aspect, more than one of the three color lights is combined into one of the sources. In yet another aspect, more than three color lights are combined in the optical element to produce a combined light.

According to one aspect, the reflective polarizing film comprises a multi-layer optical film. In one embodiment, the PBS produces a first combined light output that includes p-polarized second color light, and s-polarized first and third color light. In another embodiment, the PBS produces a p-polarized first and third color light, and an s-polarized second color light. The first combined light output can be passed through a color-selective stacked retardation filter that selectively changes the polarization of the second color light as the second color light passes through the filter. Such color-selective stacked retardation filters are available from, for example, ColorLink Inc, Boulder, CO. The filter produces a second combined light output that includes the first, second and third color lights combined to have the same polarization (e.g. s-polarization). The second combined output is useful for illumination of transmissive or reflective display mechanisms that modulate polarized light to produce an image.

The light beam includes light rays that can be collimated, convergent, or divergent when it enters the PBS. Convergent or divergent light entering the PBS can be lost through one of the faces or ends of the PBS. To avoid such losses, all of the exterior faces of a prism based PBS can be polished to enable total internal reflection (TIR) within the

PBS. Enabling TIR improves the utilization of light entering the PBS, so that substantially all of the light entering the PBS within a range of angles is redirected to exit the PBS through the desired face.

A polarization component of each color light can pass through to a polarization rotating reflector. The polarization rotating reflector deflects the propagation direction of the light and alters the magnitude of the polarization components, depending of the type and orientation of a retarder disposed in the polarization rotating reflector. The polarization rotating reflector can include a wavelength-selective mirror, such as a color-selective dichroic filter, and a retarder. The retarder can provide any desired retardation, such as an eighth-wave retarder, a quarter-wave retarder, and the like. In embodiments described herein, there is an advantage to using a quarter-wave retarder and an associated dichroic reflector. Linearly polarized light is changed to circularly polarized light as it passes through a quarter-wave retarder aligned at an angle of 45° to the axis of light polarization. Subsequent reflections from the reflective polarizer and quarter-wave retarder/reflectors in the color combiner result in efficient combined light output from the color combiner. In contrast, linearly polarized light is changed to a polarization state partway between s-polarization and p-polarization (either elliptical or linear) as it passes through other retarders and orientations, and can result in a lower efficiency of the combiner. Generally, variations in retardation and orientation can result in elliptically polarized light; however, for brevity the descriptions contained herein refer to circular polarized light, which is understood to be an idealized case of elliptical polarized light. Polarization rotating reflectors generally comprise a color-selective dichroic filter and retarder. The position of the retarder and color-selective dichroic filter relative to the adjacent light source is dependent on the desired path of each of the polarization components, and are described elsewhere with reference to the Figures. In one aspect, the reflective polarizer can be a circular polarizer such as a cholesteric liquid crystal polarizer. According to this aspect, polarization rotating reflectors can comprise color-selective dichroic filters without any associated retarders.

The components of the optical element including prisms, reflective polarizers, quarter-wave retarders, mirrors, filters or other components can be bonded together by a suitable optical adhesive. The optical adhesive used to bond the components together has an index of refraction less than or equal to the index of refraction of the prisms used in the optical element. An optical element that is fully bonded together offers advantages including alignment stability during assembly, handling and use. In some embodiments, two adjacent prisms can be bonded together using an optical adhesive. In some embodiments, a unitary optical component can incorporate the optics of the two adjacent prisms; e.g., such as a single triangular prism which incorporates the optics of two adjacent triangular prisms, as described elsewhere.

The embodiments described above can be more readily understood by reference to the Figures and their accompanying description, which follows.

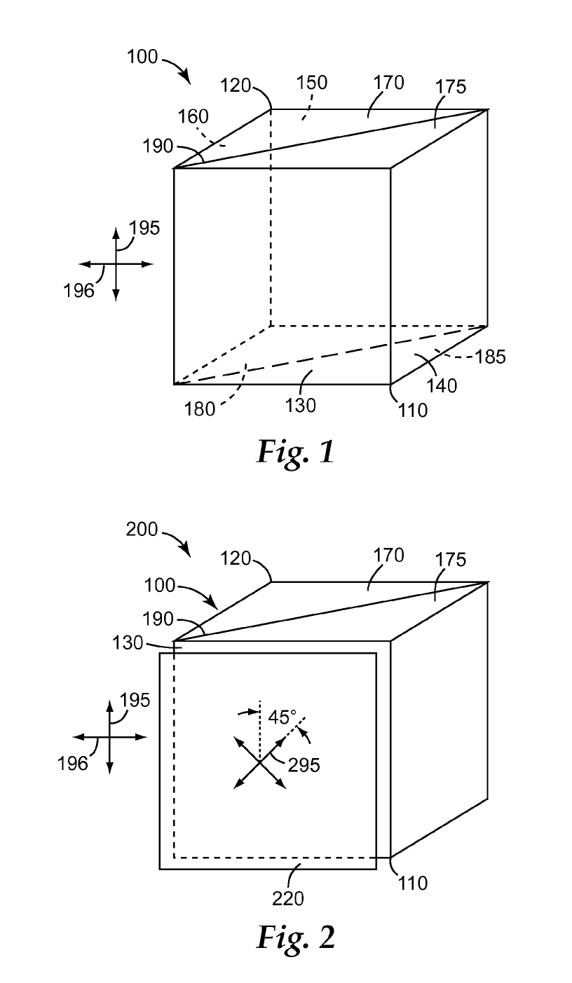

FIG. 1 is a perspective view of a PBS. PBS 100 includes a reflective polarizer 190 disposed between the diagonal faces of prisms 110 and 120. Prism 110 includes two end faces 175, 185, and a first and second prism face 130, 140 having a 90° angle between them. Prism 120 includes two end faces 170, 180, and a third and fourth prism face 150, 160 having a 90° angle between them. The first prism face 130 is parallel to the third prism face 150, and the second prism face 140 is parallel to the fourth prism face 160. The identification of the four prism faces shown in FIG. 1 with a “first”, “second”, “third” and “fourth” serves only to clarify the description of PBS 100 in the discussion that follows. First reflective polarizer 190 can be a Cartesian reflective polarizer or a non-Cartesian reflective polarizer. A non-Cartesian reflective polarizer can include multilayer inorganic films such as those produced by sequential deposition of inorganic dielectrics, such as a MacNeille polarizer. A Cartesian reflective polarizer has a polarization axis state, and includes both wire-grid polarizers and polymeric multilayer optical films such as can be produced by extrusion and subsequent stretching of a multilayer polymeric laminate. In one embodiment, reflective polarizer 190 is aligned so that one polarization axis is parallel to a first polarization state 195, and perpendicular to a second polarization state 196. In one embodiment, the first polarization state 195 can be the s-polarization state, and the second polarization state 196 can be the p-polarization state. In another embodiment, the first polarization state 195 can be the p-polarization state, and the second polarization state 196 can be the s-polarization state. As shown in FIG. 1, the first polarization state 195 is perpendicular to each of the end faces 170, 175, 180, 185.

A Cartesian reflective polarizer film provides the polarizing beam splitter with an ability to pass input light rays that are not fully collimated, and that are divergent or skewed from a central light beam axis, with high efficiency. The Cartesian reflective polarizer film can comprise a polymeric multilayer optical film that comprises multiple layers of dielectric or polymeric material. Use of dielectric films can have the advantage of low attenuation of light and high efficiency in passing light. The multilayer optical film can comprise polymeric multilayer optical films such as those described in U.S. Pat. No. 5,962,114 (Jonza et al.) or U.S. Pat. No. 6,721,096 (Bruzzone et al.).

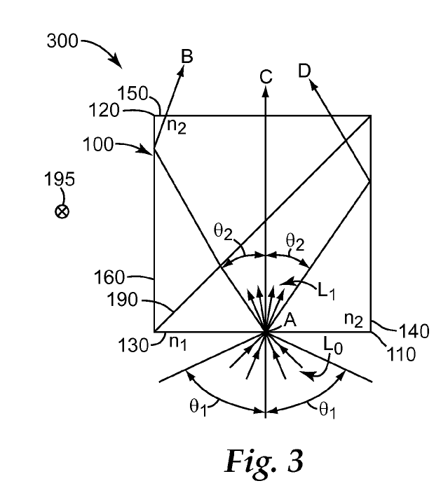

FIG. 2 is a perspective view of the alignment of a quarter-wave retarder to a PBS, as used in some embodiments. Quarter-wave retarders can be used to change the polarization state of incident light. PBS retarder system 200 includes PBS 100 having first and second prisms 110 and 120. A quarter-wave retarder 220 is disposed adjacent the first prism face 130. Reflective polarizer 190 is, for example, a Cartesian reflective polarizer film aligned to first polarization state 195. Quarter-wave retarder 220 includes a quarter-wave polarization state 295 that can be aligned at 45° to first polarization state 195. Although FIG. 2 shows polarization state 295 aligned at 45° to first polarization state 195 in a clockwise direction, polarization state 295 can instead be aligned at 45° to first polarization state 195 in a counterclockwise direction. In some embodiments, quarter-wave polarization state 295 can be aligned at any degree orientation to first polarization state 195, for example from 90° in a counter-clockwise direction to 90° in a clockwise direction. It can be advantageous to orient the retarder at approximately +/−45° as described, since circularly polarized light results when linearly polarized light passes through a quarter-wave retarder so aligned to the polarization state. Other orientations of quarter-wave retarders can result in s-polarized light not being fully transformed to p-polarized light, and p-polarized light not being fully transformed to s-polarized light upon reflection from the mirrors, resulting in reduced efficiency of the optical elements described elsewhere in this description.

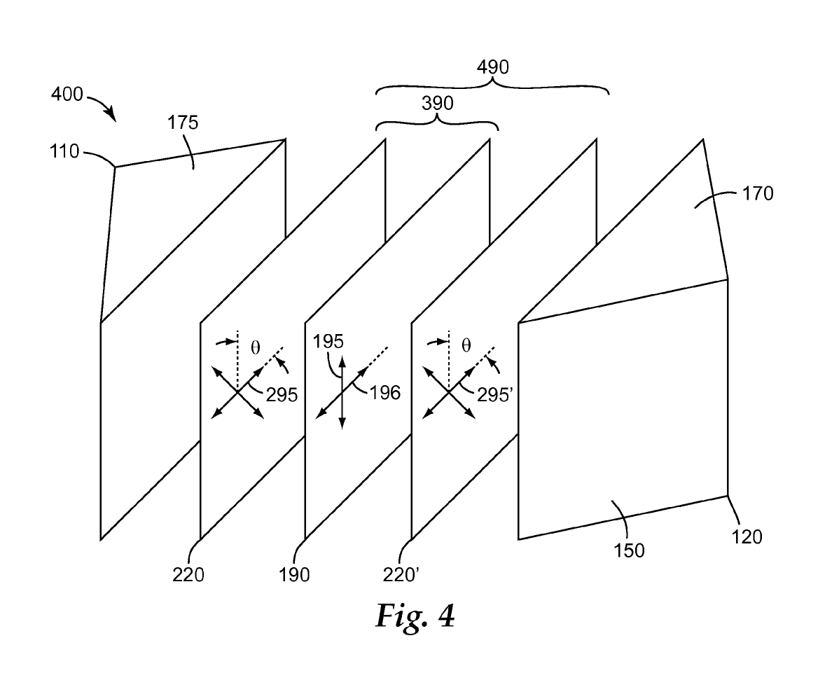

FIG. 3 shows a top view of a path of light rays within a polished PBS 300. According to one embodiment, the first, second, third and fourth prism faces 130, 140, 150, 160 of prisms 110 and 120 are polished external surfaces. According to another embodiment, all of the external faces of the PBS 100 (including end faces, not shown) are polished faces that provide TIR of oblique light rays within polished PBS 300. The polished external surfaces are in contact with a material having an index of refraction “n₁” that is less than the index of refraction “n₂” of prisms 110 and 120. TIR improves light utilization in polished PBS 300, particularly when the light directed into polished PBS 300 is not collimated along a central axis, i.e. the incoming light is either convergent or divergent. At least some light is trapped in polished PBS 300 by total internal reflections until it leaves through third prism face 150. In some cases, substantially all of the light is trapped in polished PBS 300 by total internal reflections until it leaves through third prism face 150.

As shown in FIG. 3, light rays L₀ enter first prism face 130 within a range of angles θ₁. Light rays L₁ within polished PBS 300 propagate within a range of angles θ₂ such that the TIR condition is satisfied at prism faces 140, 160 and the end faces (not shown). Light rays “AB”, “AC” and “AD” represent three of the many paths of light through polished PBS 300, that intersect reflective polarizer 190 at different angles of incidence before exiting through third prism face 150. Light rays “AB” and “AD” also both undergo TIR at prism faces 160 and 140, respectively, before exiting. It is to be understood that ranges of angles θ₁ and θ₂ can be a cone of angles so that reflections can also occur at the end faces of polished PBS 300. In one embodiment, reflective polarizer 190 is selected to efficiently split light of different polarizations over a wide range of angles of incidence. A polymeric multilayer optical film is particularly well suited for splitting light over a wide range of angles of incidence. Other reflective polarizers including MacNeille polarizers and wire-grid polarizers can be used, but are less efficient at splitting the polarized light. A MacNeille polarizer does not efficiently transmit light at angles of incidence that differ substantially from the design angle, which is typically 45 degrees to the polarization selective surface, or normal to the input face of the PBS. Efficient splitting of polarized light using a MacNeille polarizer can be limited to incidence angles below about 6 or 7 degrees from the normal, since significant reflection of the p-polarization state can occur at some larger angles, and significant transmission of s-polarization state can also occur at some larger angles. Both effects can reduce the splitting efficiency of a MacNeille polarizer. Efficient splitting of polarized light using a wire-grid polarizer typically requires an air gap adjacent one side of the wires, and efficiency drops when a wire-grid polarizer is immersed in a higher index medium. A wire-grid polarizer used for splitting polarized light is shown, for example, in PCT publication WO 2008/1002541.

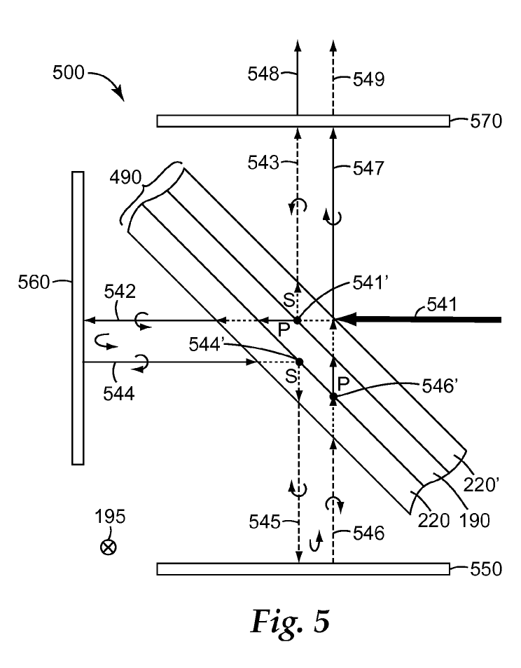

In one aspect, FIG. 4 is a perspective view of a PBS 400 that includes a first prism 110 and a second prism 120 as described elsewhere, and a reflective polarizer laminate 490 disposed on the diagonal between them. In one particular embodiment, reflective polarizer laminate 490 includes a reflective polarizer 190 disposed between a first quarter-wave retarder 220 and a second quarter-wave retarder 220′.

In one aspect, FIG. 4 is a perspective view of a PBS 400 that includes a first prism 110 and a second prism 120 as described elsewhere, and a reflective polarizer laminate 390 disposed on the diagonal between them. In one particular embodiment, reflective polarizer laminate 390 includes a first quarter-wave retarder 220 disposed between a reflective polarizer 190 and the diagonal surface of first prism 110, and the second quarter-wave retarder 220′ is omitted.

Reflective polarizer 190 can be aligned to a first polarization direction 195, and first and second quarter-wave retarders can be aligned at an angle “θ” to the first polarization direction 195. In one particular embodiment, each of the quarter-wave retarders are aligned at an angle θ=+/−45 degrees to the first polarization direction 195, as described elsewhere. In some cases, the retarder film (typically a quarter-wave plate, or QWP) retardation and orientation relative to the reflective polarizer slow-axis (polarization direction) can be varied to account for the 45 degree immersed incidence in glass. Optimal QWP parameters can be calculated for 45-deg. immersed incidence, and compare the efficiency gain of the optimal design vs. operating the conventional normal incidence QWP design at 45 degree immersed incidence.

The CC efficiency using QWP at 45 degree immersed glass incidence can be modeled using conventional optical modeling software. In some cases, the quarter-wave retarder can be aligned at approximately 45 degrees to a polarization state of the reflective polarizer. In one embodiment, the alignment can be from 30 to 60 degrees; from 40 to 50 degrees; from 43 to 47 degrees; or from 44.5 to 45.5 degrees to a polarization state of the reflective polarizer. In one particular embodiment, a shift of about 11 degrees orientation offset from θ=+/−45 degrees can result in an improved efficiency for the QWP/Polarizer/QWP laminate. In this embodiment, the alignment of the QWP to the reflective polarizer can be about θ=+/−34 degrees. In some cases, the QWP film can also be made thicker, to increase the retardation from quarter-wave (90 degree retardance) to greater than 90 degrees retardance, for example, to account for the variation due to 45 degree immersion incidence. In some cases, the retardance can yield approximately quarter-wave (i.e., 90 degree retardance), for example, 90 degrees +/−10% retardance. In some cases, the retarder can provide between approximately 90 degrees and approximately 120 degrees retardance.

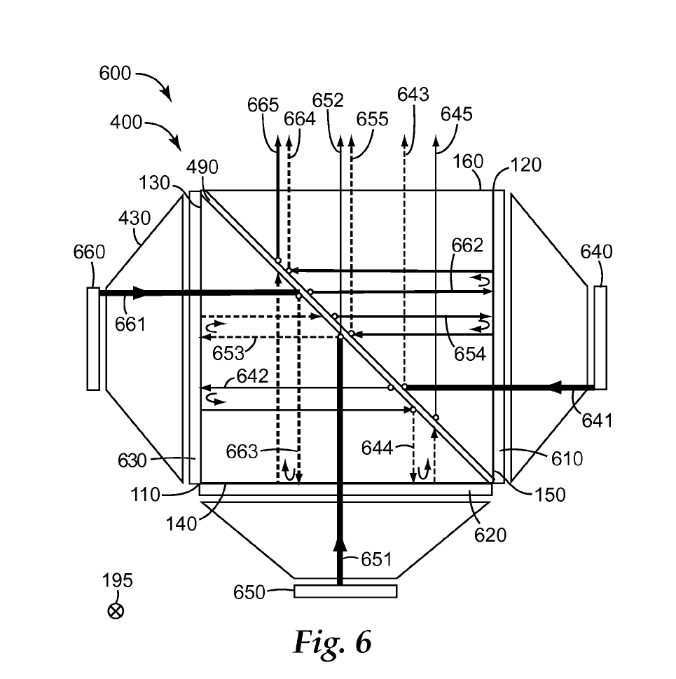

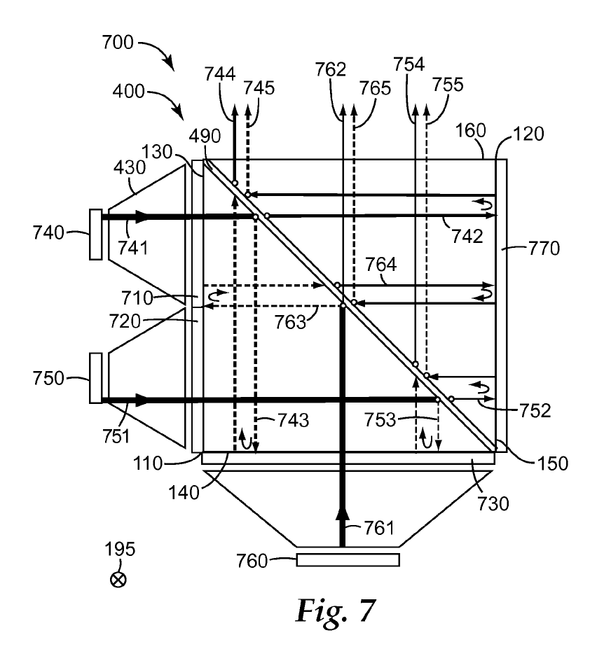

In one particular embodiment, FIG. 5 is a cross-sectional schematic of a light path 500 through a reflective polarizer laminate 490 showing the interaction with an unpolarized light 541. The detail shown in light path 500 can be used to better understand FIGS. 6-11 that follow, which are directed to color combining Light path 500 includes a first and a second broadband mirror (550, 560), a third quarter-wave retarder 570, and the reflective polarizer laminate 490. The reflective polarizer laminate 490 includes a reflective polarizer 190 disposed between a first and a second quarter-wave retarder (220, 220′), disposed relative to first polarization direction 195, as described elsewhere.

The path of unpolarized light 541 is described with reference to FIG. 5. Unpolarized light 541 becomes a combined p-polarized light 548 and s-polarized light 549 after leaving third quarter-wave retarder 570. Depending on the nature and orientation of the components within the reflective polarizer laminate 490, as described elsewere, the combined p-polarized light 548 and s-polarized light 549 may be considered to be “unpolarized”, or may retain some degree of polarization (elliptical or linear).

Unpolarized light 541 intersects reflective polarizer laminate 490 at an angle of approximately 45 degrees, and passes through second quarter-wave retarder 220′, intersecting reflective polarizer 190 at position 541′ where it is split into an s-polarized component at position 541′ and a p-polarized component at position 541′.

The s-polarized component at position 541′ reflects from reflective polarizer 190, changes to s-circular polarized light 543 as it passes through second quarter-wave retarder 220′, and becomes p-polarized light 548 as it passes through third quarter-wave retarder 570.

The p-polarized component at position 541′ passes through reflective polarizer 190 and changes to p-circular polarized light 542 after passing through first quarter-wave retarder 220. P-circular polarized light 542 reflects from second broadband mirror 560, changing the direction of circular polarization, and becomes s-polarized light at position 544′. S-polarized light at position 544′ reflects from reflective polarizer 190, becomes s-circularly polarized light 545 as it passes through first quarter-wave retarder 220, reflects from first broadband mirror 550 changing the direction of circular polarization, and becomes p-polarized light at position 546′ after passing through first quarter wave retarder 220. P-polarized light at position 546′ passes through reflective polarizer 190 and becomes p-circularly polarized light 547 after passing through second quarter-wave retarder 220′. P-circularly polarized light 547 passes through third quarter-wave retarder 570 and becomes s-polarized light 549.

In one aspect, FIG. 6 is a top schematic view of an optical element configured as a color combiner 600 that includes a PBS 400. Color combiner 600 can be used with a variety of light sources as described elsewhere. The paths of light rays of each polarization state emitted from a first, a second, and a third light source (640, 650, 660) are shown in FIG. 6, to more clearly illustrate the function of the various components of color combiner 600. PBS 400 includes a reflective polarizer laminate 490 aligned to the first polarization state 195, disposed between the diagonal faces of first and second prisms 110, 120, as described elsewhere.

A first, a second, and a third wavelength-selective filter (610, 620, 630) are disposed facing the third, the second and the first prism faces (150, 140, 130) respectively. Each of the first, second, and third wavelength-selective filters (610, 620, 630) can be a color-selective dichroic filter selected to transmit a first, a second, and a third wavelength spectrum of light, respectively, and reflect other wavelength spectrums of light. In one particular embodiment, each of the color-selective dichroic filters can be immediately adjacent the respective prism face, such as coated directly on the prism face. In one aspect, the reflective polarizer laminate 490 can comprise a polymeric multilayer optical film.

The color-selective dichroic filters (610, 620, 630), and reflective polarizer laminate 490 cooperate to transmit combined light through the fourth prism face 160. Each unpolarized light input is split into a p-circularly polarized and an s-circularly polarized component that are recombined through the fourth prism face 160. In some cases, the nature, alignment, and efficiency of the components in the reflective polarizer laminate may result in some polarization (i.e., elliptical or circular) of the combined light, as described elsewhere. In one embodiment described below, each retarder 220 in color combiner 600 is a quarter-wave retarder orientated at approximately 45 degrees to the first polarization state 195.

According to another aspect, an optional light tunnel 430 or assemblies of lenses (not shown) can be provided for each of the first, second, and third light sources (640, 650, 660), to provide spacing that separates the light sources from the polarizing beam splitter, as well as provide for some collimation of light. Light tunnels could have straight or curved sides, or they could be replaced by a lens system. Different approaches may be preferred depending on specific details of each application, and those with skill in the art will face no difficulty in selecting the optimal approach for a specific application.

An optional integrator (not shown) can be provided at the output of color combiner 600 to increase uniformity of combined light outputs. According to one aspect, each light source (640, 650, 660) comprises one or more light emitting diodes (LED's). Various light sources can be used such as lasers, laser diodes, organic LED's (OLED's), and non solid state light sources such as ultra high pressure (UHP), halogen or xenon lamps with appropriate collectors or reflectors. Light sources, light tunnels, lenses, and light integrators useful in the present invention are further described, for example, in Published U.S. Patent Application No. US 2008/0285129, the disclosure of which is herein included in its entirety.

The path of a first color light 641 will now be described with reference to FIG. 6, where unpolarized first color light 641 exits fourth prism face 160 as p-circular polarized first color light 645 and s-circular polarized first color light 643.

First light source 640 injects unpolarized first color light 641 through first color-selective dichroic filter 610, enters PBS 400 through third prism face 150, intercepts reflective polarizer laminate 490, and is split into reflected s-circular polarized first color light 643 and transmitted p-circular polarized first color light 642. Reflected s-circular polarized first color light 643 exits fourth prism face 160 as s-circular polarized first color light 643.

Transmitted p-circular polarized first color light 642 exits reflective polarizer laminate 490, and reflects from third color-selective dichroic filter 630 changing the direction of circular polarization, and intercepts reflective polarizer laminate 490. P-circular polarized first color light 642 exits reflective polarizer laminate 490 as reflected s-circular polarized first light 644. S-circular polarized first light 644 reflects from second color-selective dichroic filter 620 changing the direction of circular polarization, and intercepts reflective polarizer laminate 490. S-circular polarized first color light 644 exits reflective polarizer laminate 490 as transmitted p-circular polarized first color light 645, and passes through fourth prism face 160 as p-circular polarized first color light 645.

The path of a second color light 651 will now be described with reference to FIG. 6, where unpolarized second color light 651 exits fourth prism face 160 as p-circular polarized second color light 652 and s-circular polarized first color light 655.

Second light source 650 injects unpolarized second color light 651 through second color-selective dichroic filter 620, enters PBS 400 through second prism face 140, intercepts reflective polarizer laminate 490, and is split into reflected s-circular polarized second color light 653 and transmitted p-circular polarized second color light 652. Transmitted p-circular polarized second color light 652 exits fourth prism face 160 as p-circular polarized second color light 652.

Reflected s-circular polarized second color light 653 reflects from third color-selective dichroic filter 630 changing the direction of circular polarization, and intercepts reflective polarizer laminate 490. S-circular polarized second color light 653 exits reflective polarizer laminate 490 as transmitted p-circular polarized second color light 654, reflects from first color-selective dichroic filter 610 changing the direction of circular polarization, and intercepts reflective polarizer laminate 490. P-circular polarized second color light 654 exits reflective polarizer laminate 490 as reflected s-circular polarized second color light 655, and passes through fourth prism face 160 as s-circular polarized second color light 655.

The path of a third color light 661 will now be described with reference to FIG. 6, where unpolarized third color light 661 exits fourth prism face 160 as p-circular polarized third color light 665 and s-circular polarized third color light 664.

Third light source 660 injects unpolarized third color light 661 through third color-selective dichroic filter 630, enters PBS 400 through first prism face 130, intercepts reflective polarizer laminate 490, and is split into reflected s-circular polarized third color light 663 and transmitted p-circular polarized third color light 662.

Reflected s-circular polarized third color light 663 reflects from second color-selective dichroic filter 620 changing the direction of circular polarization, and intercepts reflective polarizer laminate 490. S-circular polarized third color light 663 exits reflective polarizer laminate 490 as transmitted p-circular polarized third color light 665, and passes through fourth prism face 160 as p-circular polarized third color light 665.

Transmitted p-circular polarized third color light 662 reflects from first color-selective dichroic filter 610 changing the direction of circular polarization, and intercepts reflective polarizer laminate 490. P-circular polarized third color light 662 exits reflective polarizer laminate 490 as reflected s-circular polarized third color light 664, and passes through fourth prism face 160 as s-circular polarized second color light 664.

In one embodiment, first color light 641 is green light, second color light 651 is red light, and third color light 661 is blue light. According to this embodiment, first color-selective dichroic filter 610 is a red and blue (i.e., magenta) light reflecting and green light transmitting dichroic filter; second color-selective dichroic filter 620 is a green and blue light reflecting and red light transmitting dichroic filter; and third color-selective dichroic filter 630 is a green and red light reflecting and blue light transmitting dichroic filter.

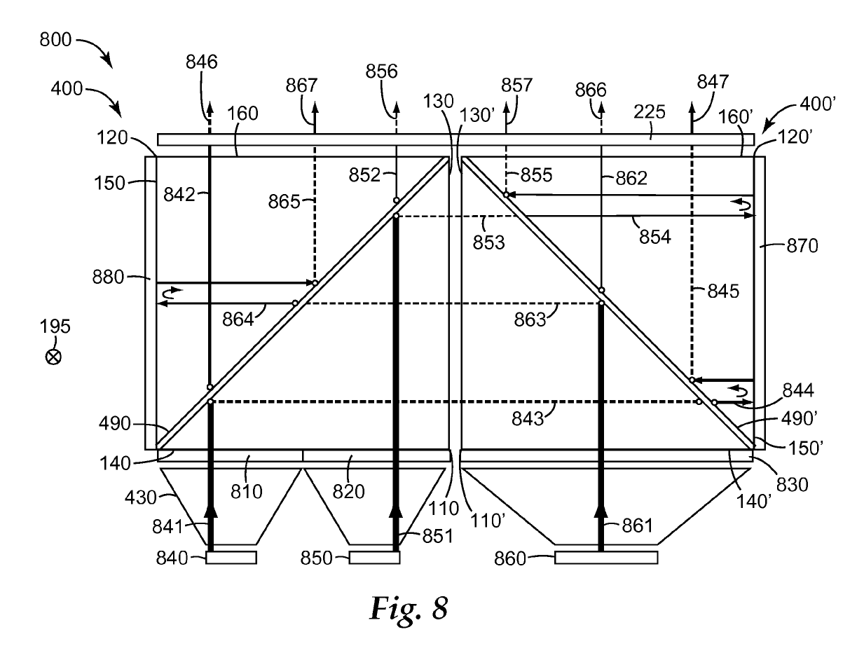

In one aspect, FIG. 7 is a top schematic view of an optical element configured as a color combiner 700 that includes a PBS 400. Color combiner 700 can be used with a variety of light sources as described elsewhere. The paths of light rays of each polarization state emitted from a first, a second, and a third light source (740, 750, 760) are shown in FIG. 7, to more clearly illustrate the function of the various components of color combiner 700. PBS 400 includes a reflective polarizer laminate 490 aligned to the first polarization state 195, disposed between the diagonal faces of first and second prisms 110, 120, as described elsewhere.

A first and a second wavelength-selective filter (710, 720) are disposed facing the first prism face 130, and a third wavelength-selective filter 730 is disposed facing the second prism face 140. A broadband mirror 770 is disposed facing the third prism face 150. Each of the first, second, and third wavelength-selective filters (710, 720, 730) can be a color-selective dichroic filter selected to transmit a first, a second, and a third wavelength spectrum of light, respectively, and reflect other wavelength spectrums of light. In one particular embodiment, each of the color-selective dichroic filters and the broadband mirror can be immediately adjacent the respective prism face, such as coated directly on the prism face. In one aspect, the reflective polarizer laminate 490 can comprise a polymeric multilayer optical film.

The color-selective dichroic filters (710, 720, 730), and reflective polarizer laminate 490 cooperate to transmit combined light through the fourth prism face 160. Each unpolarized light input is split into a p-circularly polarized and an s-circularly polarized component that are recombined through the fourth prism face 160. In some cases, the nature, alignment, and efficiency of the components in the reflective polarizer laminate may result in some polarization (i.e., elliptical or circular) of the combined light, as described elsewhere. In one embodiment described below, each retarder 220 in color combiner 700 is a quarter-wave retarder orientated at approximately 45 degrees to the first polarization state 195.

According to another aspect, an optional light tunnel 430 or assemblies of lenses (not shown) can be provided for each of the first, second, and third light sources (740, 750, 760), as described elsewhere. According to another aspect, an optional integrator can be provided at the output of color combiner 700, as described elsewhere. According to one aspect, each light source can be any of the light sources described elsewhere, for example, with reference to FIG. 6.

The path of a first color light 741 will now be described with reference to FIG. 7, where unpolarized first color light 741 exits fourth prism face 160 as p-circular polarized first color light 744 and s-circular polarized first color light 745.

First light source 740 injects unpolarized first color light 741 through first color-selective dichroic filter 710, enters PBS 400 through first prism face 130, intercepts reflective polarizer laminate 490, and is split into reflected s-circular polarized first color light 743 and transmitted p-circular polarized first color light 742.

Reflected s-circular polarized first color light 743 reflects from third color-selective dichroic filter 730 changing the direction of circular polarization, and intercepts reflective polarizer laminate 490. S-circular polarized first color light 743 exits reflective polarizer laminate 490 as transmitted p-circular polarized first color light 744, and exits fourth prism face 160 as p-circular polarized first color light 744.

Transmitted p-circular polarized first color light 742 exits reflective polarizer laminate 490, reflects from broadband mirror 770 changing the direction of circular polarization, and intercepts reflective polarizer laminate 490. P-circular polarized first color light 742 exits reflective polarizer laminate 490 as reflected s-circular polarized first light 745, and passes through fourth prism face 160 as s-circular polarized first color light 745.

The path of a second color light 751 will now be described with reference to FIG. 7, where unpolarized second color light 751 exits fourth prism face 160 as p-circular polarized second color light 754 and s-circular polarized second color light 755.

Second light source 750 injects unpolarized second color light 751 through first color-selective dichroic filter 710, enters PBS 400 through first prism face 130, intercepts reflective polarizer laminate 490, and is split into reflected s-circular polarized second color light 753 and transmitted p-circular polarized second color light 752.

Reflected s-circular polarized second color light 753 reflects from third color-selective dichroic filter 730 changing the direction of circular polarization, and intercepts reflective polarizer laminate 490. S-circular polarized second color light 753 exits reflective polarizer laminate 490 as transmitted p-circular polarized second color light 754, and exits fourth prism face 160 as p-circular polarized second color light 754.

Transmitted p-circular polarized second color light 742 exits reflective polarizer laminate 490, reflects from broadband mirror 770 changing the direction of circular polarization, and intercepts reflective polarizer laminate 490. P-circular polarized second color light 752 exits reflective polarizer laminate 490 as reflected s-circular polarized second light 755, and passes through fourth prism face 160 as s-circular polarized second color light 755.

The path of a third color light 761 will now be described with reference to FIG. 7, where unpolarized third color light 761 exits fourth prism face 160 as p-circular polarized third color light 762 and s-circular polarized first color light 765.

Third light source 760 injects unpolarized third color light 761 through third color-selective dichroic filter 730, enters PBS 400 through second prism face 140, intercepts reflective polarizer laminate 490, and is split into reflected s-circular polarized third color light 763 and transmitted p-circular polarized third color light 762. Transmitted p-circular polarized third color light 762 exits fourth prism face 160 as p-circular polarized third color light 762.

Reflected s-circular polarized third color light 763 reflects from either first or second color-selective dichroic filter (710, 720) changing the direction of circular polarization, and intercepts reflective polarizer laminate 490. S-circular polarized third color light 763 exits reflective polarizer laminate 490 as transmitted p-circular polarized third color light 764, reflects from broadband mirror 770 changing the direction of circular polarization, and intercepts reflective polarizer laminate 490. P-circular polarized third color light 764 exits reflective polarizer laminate 490 as reflected s-circular polarized third color light 765, and passes through fourth prism face 160 as s-circular polarized third color light 765.

In one embodiment, first color light 741 is blue light, second color light 751 is red light, and third color light 761 is green light. According to this embodiment, first color-selective dichroic filter 710 is a red and green light reflecting and blue light transmitting dichroic filter; second color-selective dichroic filter 720 is a green and blue light reflecting and red light transmitting dichroic filter; and third color-selective dichroic filter 730 is a blue and red light reflecting and green light transmitting dichroic filter.

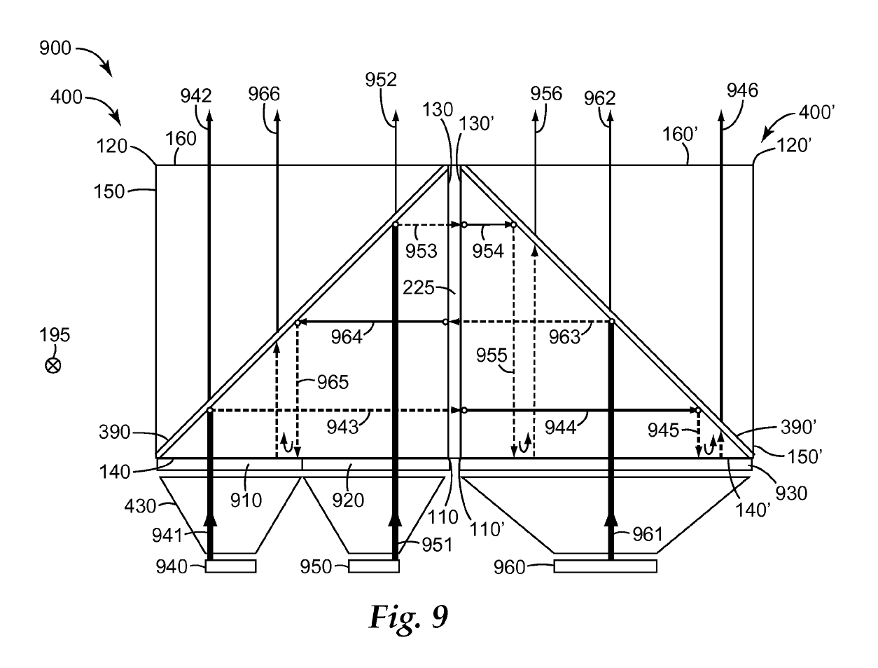

In one aspect, FIG. 8 is a top view schematic of an optical element configured as a color combiner 800 that includes a first PBS 400 and a second PBS 400′. Color combiner 800 can be used with a variety of light sources as described elsewhere. The paths of light rays of each polarization state emitted from a first, a second, and a third light source (840, 850, 860) are shown in FIG. 8, to more clearly illustrate the function of the various components of color combiner 800. First PBS 400 includes a first reflective polarizer laminate 490 aligned to the first polarization state 195, disposed between the diagonal faces of first and second prisms 110, 120, as described elsewhere. Second PBS 400′ includes a second reflective polarizer laminate 490′ aligned to the first polarization state 195, disposed between the diagonal faces of first and second prisms 110′, 120′, as described elsewhere. A first broadband reflector 870 is disposed adjacent third prism face 150′ of second PBS 400′, and a second broadband reflector 880 is disposed adjacent third prism face 150 of first PBS 400.

A first and a second wavelength-selective filter (810, 820) are disposed facing the second prism face 140 of the first PBS 400. A third wavelength-selective filter 830 is disposed facing the second prism face 140′ of the second PBS 400′. Each of the first, second, and third wavelength-selective filters (810, 820, 830) can be a color-selective dichroic filter selected to transmit a first, a second, and a third wavelength spectrum of light, respectively, and reflect other wavelength spectrums of light. In one particular embodiment, each of the color-selective dichroic filters and the broadband mirrors can be immediately adjacent the respective prism face, such as coated directly on the prism face. In one aspect, the reflective polarizer 190 can comprise a polymeric multilayer optical film.

The color-selective dichroic filters (810, 820, 830), and reflective polarizer laminates 490, 490′ cooperate to transmit combined light through the fourth prism faces (160, 160′). Each unpolarized light input is split into a p-circularly polarized and an s-circularly polarized component that are recombined through the fourth prism faces (160, 160′). In some cases, the nature, alignment, and efficiency of the components in the reflective polarizer laminate may result in some polarization (i.e., elliptical or circular) of the combined light, as described elsewhere. In one embodiment described below, each retarder 220 in color combiner 800 is a quarter-wave retarder orientated at approximately 45 degrees to the first polarization state 195.

An optional retarder 225 can be disposed facing the fourth prism faces (160, 160′). The optional retarder 225, color-selective dichroic filters (810, 820, 830), reflective polarizer laminates (490, 490′), and broadband reflectors (870, 880) cooperate to transmit orthogonal linear polarization states of each color light through the fourth prism faces (160, 160′) of the first and second PBS (400, 400′), respectively. In one embodiment described below, retarder 225 is a quarter-wave retarder orientated at approximately 45 degrees to the first polarization state 195.

According to another aspect, an optional light tunnel 430 or assemblies of lenses (not shown) can be provided for each of the first, second, and third light sources (840, 850, 860), as described elsewhere. According to another aspect, an optional integrator can be provided at the output of color combiner 800, as described elsewhere. According to one aspect, each light source can be any of the light sources described elsewhere, for example, with reference to FIG. 6.

The path of a first color light 841 will now be described with reference to FIG. 8, where unpolarized first color light 841 exits fourth prism face 160 of first PBS 400 as p-circular polarized first color light 842 and fourth prism face 160′ of second PBS 400′ as s-circular polarized first color light 845. The optional quarter-wave retarder 225 changes the circular polarized lights to s-polarized first color light 846 and p-polarized first color light 847, respectively.

First light source 840 injects unpolarized first color light 841 through first color-selective dichroic filter 810, enters first PBS 400 through second prism face 140, intercepts first reflective polarizer laminate 490, and is split into transmitted p-circular polarized first color light 842 and reflected s-circular polarized first color light 843. Transmitted p-circular polarized first color light 842 exits first PBS 400 through fourth prism face 160, and changes to s-polarized first color light 846 as it passes through optional quarter-wave retarder 225.

Reflected s-circular polarized first color light 843 exits first PBS 400 through first prism face 130, enters second PBS 400′ through first prism face 130′, and intercepts second reflective polarizer laminate 490′. S-circular polarized first color light 843 exits second reflective polarizer laminate 490′ as transmitted p-circular polarized first color light 844, reflects from first broadband mirror 870 changing the direction of circular polarization, and intercepts second reflective polarizer laminate 490′. P-circular polarized first color light 844 exits second reflective polarizer laminate 490′ as reflected s-circular polarized first color light 845, exits second PBS 400′ through fourth prism face 160′, and changes to p-polarized first color light 847 as it passes through optional quarter-wave retarder 225.

The path of a second color light 851 will now be described with reference to FIG. 8, where unpolarized second color light 851 exits fourth prism face 160 of first PBS 400 as p-circular polarized second color light 852 and fourth prism face 160′ of second PBS 400′ as s-circular polarized second color light 855. The optional quarter-wave retarder 225 changes the circular polarized lights to s-polarized second color light 856 and p-polarized second color light 857, respectively.

Second light source 850 injects unpolarized second color light 851 through second color-selective dichroic filter 820, enters first PBS 400 through second prism face 140, intercepts first reflective polarizer laminate 490, and is split into transmitted p-circular polarized second color light 852 and reflected s-circular polarized second color light 853. Transmitted p-circular polarized second color light 852 exits first PBS 400 through fourth prism face 160, and changes to s-polarized second color light 856 as it passes through optional quarter-wave retarder 225.

Reflected s-circular polarized second color light 853 exits first PBS 400 through first prism face 130, enters second PBS 400′ through first prism face 130′, and intercepts second reflective polarizer laminate 490′. S-circular polarized second color light 853 exits second reflective polarizer laminate 490′ as transmitted p-circular polarized second color light 854, reflects from first broadband mirror 870 changing the direction of circular polarization, and intercepts second reflective polarizer laminate 490′. P-circular polarized second color light 854 exits second reflective polarizer laminate 490′ as reflected s-circular polarized second color light 855, exits second PBS 400′ through fourth prism face 160′, and changes to p-polarized second color light 857 as it passes through optional quarter-wave retarder 225.

The path of a third color light 861 will now be described with reference to FIG. 8, where unpolarized third color light 861 exits fourth prism face 160 of first PBS 400 as s-circular polarized third color light 865 and fourth prism face 160′ of second PBS 400′ as p-circular polarized third color light 862. The optional quarter-wave retarder 225 changes the circular polarized lights to p-polarized third color light 867 and s-polarized third color light 866, respectively.

Third light source 860 injects unpolarized third color light 861 through third color-selective dichroic filter 830, enters second PBS 400′ through second prism face 140′, intercepts second reflective polarizer laminate 490′, and is split into transmitted p-circular polarized third color light 862 and reflected s-circular polarized third color light 863. Transmitted p-circular polarized third color light 862 exits second PBS 400′ through fourth prism face 160′, and changes to p-polarized third color light 866 as it passes through optional quarter-wave retarder 225.

Reflected s-circular polarized third color light 863 exits second PBS 400′ through first prism face 130′, enters first PBS 400 through first prism face 130, and intercepts first reflective polarizer laminate 490. S-circular polarized third color light 863 exits first reflective polarizer laminate 490 as transmitted p-circular polarized third color light 864, reflects from second broadband mirror 880 changing the direction of circular polarization, and intercepts first reflective polarizer laminate 490. P-circular polarized third color light 864 exits first reflective polarizer laminate 490 as reflected s-circular polarized third color light 865, exits first PBS 400 through fourth prism face 160, and changes to p-polarized third color light 867 as it passes through optional quarter-wave retarder 225.

In one embodiment, first color light 841 is red light, second color light 851 is blue light, and third color light 861 is green light. According to this embodiment, first color-selective dichroic filter 810 is a blue and green light reflecting and red light transmitting dichroic filter; second color-selective dichroic filter 820 is a green and red light reflecting and blue light transmitting dichroic filter; and third color-selective dichroic filter 830 is a blue and red light reflecting and green light transmitting dichroic filter.

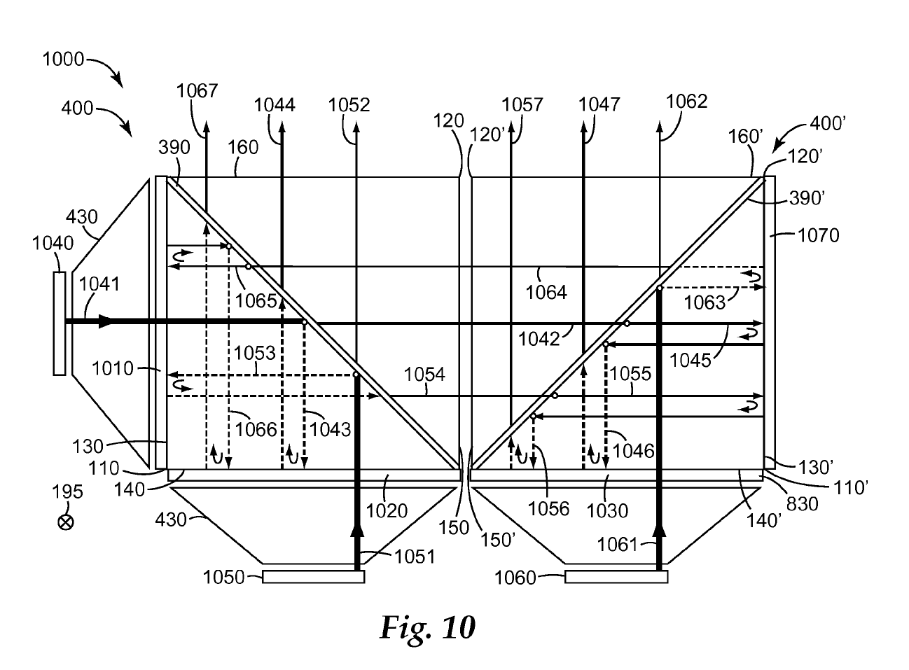

In one aspect, FIG. 9 is a top view schematic of an optical element configured as a color combiner 900 that includes a first PBS 400 and a second PBS 400′. Color combiner 900 can be used with a variety of light sources as described elsewhere. The paths of light rays of each polarization state emitted from a first, a second, and a third light source (940, 950, 960) are shown in FIG. 9, to more clearly illustrate the function of the various components of color combiner 900.

First PBS 400 includes a first reflective polarizer laminate 390 aligned to the first polarization state 195, disposed between the diagonal faces of first and second prisms 110, 120, as described elsewhere. Second PBS 400′ includes a second reflective polarizer laminate 390′ aligned to the first polarization state 195, disposed between the diagonal faces of first and second prisms 110′, 120′, as described elsewhere. The first and second reflective polarizer laminate (390, 390′) each include only one retarder disposed between the reflective polarizer 190 and respective first prism (110, 110′) of PBS (400, 400′), as shown in FIG. 4.

A first and a second wavelength-selective filter (910, 920) are disposed facing the second prism face 140 of the first PBS 400. A third wavelength-selective filter 930 is disposed facing the second prism face 140′ of the second PBS 400′. Each of the first, second, and third wavelength-selective filters (910, 920, 930) can be a color-selective dichroic filter selected to transmit a first, a second, and a third wavelength spectrum of light, respectively, and reflect other wavelength spectrums of light. In one particular embodiment, each of the color-selective dichroic filters can be immediately adjacent the respective prism face, such as coated directly on the prism face. In one aspect, the reflective polarizer 190 can comprise a polymeric multilayer optical film.

The color-selective dichroic filters (910, 920, 930), and reflective polarizer laminates 390, 390′ cooperate to transmit combined light through the fourth prism faces (160, 160′). Each unpolarized light input is split into a p-polarized and an s-circularly polarized component. The s-circularly polarized component is converted to a p-polarized component resulting in a p-polarized combined output through the fourth prism faces (160, 160′). In some cases, the nature, alignment, and efficiency of the components in the reflective polarizer laminate may result in some polarization (i.e., elliptical or circular) of the combined light, as described elsewhere. In one embodiment described below, each retarder 220 in color combiner 900 is a quarter-wave retarder orientated at approximately 45 degrees to the first polarization state 195.

A half-wave retarder 225 is disposed between the first prism faces (130, 130′) of first and second PBS (400, 400′), respectively, as shown in FIG. 9. The half-wave retarder 225, color-selective dichroic filters (910, 920, 930), and reflective polarizer laminates (390, 390′) cooperate to convert circular polarization states of each color light to the corresponding orthogonal circular polarization state. In one embodiment described below, half-wave retarder 225 is orientated at approximately 45 degrees to the first polarization state 195.

According to another aspect, an optional light tunnel 430 or assemblies of lenses (not shown) can be provided for each of the first, second, and third light sources (940, 950, 960), as described elsewhere. According to another aspect, an optional integrator can be provided at the output of color combiner 900, as described elsewhere. According to one aspect, each light source can be any of the light sources described elsewhere, for example, with reference to FIG. 6.

The path of a first color light 941 will now be described with reference to FIG. 9, where unpolarized first color light 941 exits fourth prism face 160 of first PBS 400 as p-polarized first color light 942 and fourth prism face 160′ of second PBS 400′ as p-polarized first color light 946.

First light source 940 injects unpolarized first color light 941 through first color-selective dichroic filter 910, enters first PBS 400 through second prism face 140, intercepts first reflective polarizer laminate 390, and is split into transmitted p-polarized first color light 942 and reflected s-circular polarized first color light 943. Transmitted p-polarized first color light 842 exits first PBS 400 through fourth prism face 160.

Reflected s-circular polarized first color light 943 exits first PBS 400 through first prism face 130, changes to p-circular polarized first color light 944 as it passes through half-wave retarder 225, enters second PBS 400′ through first prism face 130′, and intercepts second reflective polarizer laminate 390′. P-circular polarized first color light 944 exits second reflective polarizer laminate 390′ as reflected s-circular polarized first color light 945, reflects from third color-selective dichroic filter 930 changing the direction of circular polarization, and intercepts second reflective polarizer laminate 390′. S-circular polarized first color light 945 exits second reflective polarizer laminate 390′ as transmitted p-polarized first color light 946, and exits second PBS 400′ through fourth prism face 160′.

The path of a second color light 951 will now be described with reference to FIG. 9, where unpolarized second color light 951 exits fourth prism face 160 of first PBS 400 as p-polarized second color light 952 and fourth prism face 160′ of second PBS 400′ as p-polarized second color light 956.

Second light source 950 injects unpolarized second color light 951 through second color-selective dichroic filter 920, enters first PBS 400 through second prism face 140, intercepts first reflective polarizer laminate 390, and is split into transmitted p-polarized second color light 952 and reflected s-circular polarized second color light 953. Transmitted p-polarized second color light 952 exits first PBS 400 through fourth prism face 160.

Reflected s-circular polarized second color light 953 exits first PBS 400 through first prism face 130, changes to p-circular polarized second color light 954 as it passes through half-wave retarder 225, enters second PBS 400′ through first prism face 130′, and intercepts second reflective polarizer laminate 390′. P-circular polarized second color light 954 exits second reflective polarizer laminate 390′ as reflected s-circular polarized second color light 955, reflects from third color-selective dichroic filter 930 changing the direction of circular polarization, and intercepts second reflective polarizer laminate 390′. S-circular polarized second color light 955 exits second reflective polarizer laminate 390′ as transmitted p-polarized second color light 956, and exits second PBS 400′ through fourth prism face 160′ as p-polarized second color light 956.

The path of a third color light 961 will now be described with reference to FIG. 9, where unpolarized third color light 961 exits fourth prism face 160′ of second PBS 400′ as p-polarized third color light 962 and fourth prism face 160 of first PBS 400 as p-polarized third color light 966.

Third light source 960 injects unpolarized third color light 961 through third color-selective dichroic filter 930, enters second PBS 400′ through second prism face 140′, intercepts second reflective polarizer laminate 390′, and is split into transmitted p-polarized third color light 962 and reflected s-circular polarized third color light 963. Transmitted p-polarized third color light 962 exits second PBS 400′ through fourth prism face 160′.

Reflected s-circular polarized third color light 963 exits second PBS 400′ through first prism face 130′, changes to p-circular polarized third color light 964 as it passes through half-wave retarder 225, enters first PBS 400 through first prism face 130, and intercepts first reflective polarizer laminate 390. P-circular polarized third color light 964 exits first reflective polarizer laminate 390 as reflected s-circular polarized third color light 965, reflects from either first or second color-selective dichroic filter (910, 920) changing the direction of circular polarization, and intercepts first reflective polarizer laminate 390. S-circular polarized third color light 965 exits first reflective polarizer laminate 390 as transmitted p-polarized third color light 966, and exits first PBS 400 through fourth prism face 160 as p-polarized third color light 966.

In one embodiment, first color light 941 is red light, second color light 951 is blue light, and third color light 961 is green light. According to this embodiment, first color-selective dichroic filter 910 is a blue and green light reflecting and red light transmitting dichroic filter; second color-selective dichroic filter 920 is a green and red light reflecting and blue light transmitting dichroic filter; and third color-selective dichroic filter 930 is a blue and red light reflecting and green light transmitting dichroic filter.

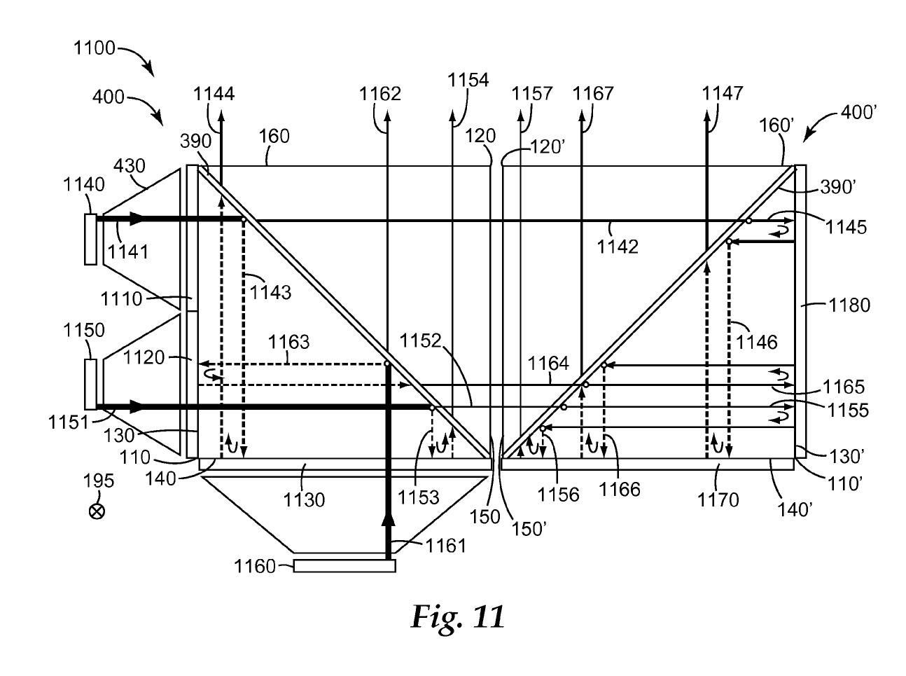

In one aspect, FIG. 10 is a top view schematic of an optical element configured as a color combiner 1000 that includes a first PBS 400 and a second PBS 400′. Color combiner 1000 can be used with a variety of light sources as described elsewhere. The paths of light rays of each polarization state emitted from a first, a second, and a third light source (1040, 1050, 1060) are shown in FIG. 10, to more clearly illustrate the function of the various components of color combiner 1000.

First PBS 400 includes a first reflective polarizer laminate 390 aligned to the first polarization state 195, disposed between the diagonal faces of first and second prisms 110, 120, as described elsewhere. Second PBS 400′ includes a second reflective polarizer laminate 390′ aligned to the first polarization state 195, disposed between the diagonal faces of first and second prisms 110′, 120′, as described elsewhere. The first and second reflective polarizer laminate (390, 390′) each include only one retarder disposed between the reflective polarizer 190 and respective first prism (110, 110′) of PBS (400, 400′), as shown in FIG. 4. A broadband reflector 1070 is disposed adjacent first prism face 130′ of second PBS 400′.

A first wavelength-selective filter 1010 is disposed facing the first prism face 130 of the first PBS 400. A second wavelength-selective filter 1020 is disposed facing the second prism face 140 of the first PBS 400. A third wavelength-selective filter 1030 is disposed facing the second prism face 140′ of the second PBS 400. Each of the first, second, and third wavelength-selective filters (1010, 1020, 1030) can be a color-selective dichroic filter selected to transmit a first, a second, and a third wavelength spectrum of light, respectively, and reflect other wavelength spectrums of light. In one particular embodiment, each of the color-selective dichroic filters and the broadband mirror can be immediately adjacent the respective prism face, such as coated directly on the prism face. In one aspect, the reflective polarizer 190 can comprise a polymeric multilayer optical film.

The color-selective dichroic filters (1010, 1020, 1030), broadband mirror 1070, and reflective polarizer laminates 390, 390′ cooperate to transmit combined light through the fourth prism faces (160, 160′). Each unpolarized light input is split into a p-polarized and an s-circularly polarized component. The s-circularly polarized component is converted to a p-polarized component resulting in a p-polarized combined output through the fourth prism faces (160, 160′). In some cases, the nature, alignment, and efficiency of the components in the reflective polarizer laminate may result in some polarization (i.e., elliptical or circular) of the combined light, as described elsewhere. In one embodiment described below, each retarder 220 in color combiner 1000 is a quarter-wave retarder orientated at approximately 45 degrees to the first polarization state 195.

According to another aspect, an optional light tunnel 430 or assemblies of lenses (not shown) can be provided for each of the first, second, and third light sources (1040, 1050, 1060), as described elsewhere. According to another aspect, an optional integrator can be provided at the output of color combiner 1000, as described elsewhere. According to one aspect, each light source can be any of the light sources described elsewhere, for example, with reference to FIG. 6.

The path of a first color light 1041 will now be described with reference to FIG. 10, where unpolarized first color light 1041 exits fourth prism face 160 of first PBS 400 as p-polarized first color light 1044 and fourth prism face 160′ of second PBS 400′ as p-polarized first color light 1047.

First light source 1040 injects unpolarized first color light 1041 through first color-selective dichroic filter 1010, enters first PBS 400 through first prism face 130, intercepts first reflective polarizer laminate 390, and is split into transmitted p-polarized first color light 1042 and reflected s-circular polarized first color light 1043.

Transmitted p-polarized first color light 1042 exits first PBS 400 through third prism face 150, enters second PBS 400′ through third prism face 150′, intercepts second reflective polarizer laminate 390′, and is transmitted as p-circular polarized first color light 1045. P-circular polarized first color light 1045 reflects from broadband mirror 1070 changing the direction of circular polarization, intercepts second reflective polarizer laminate 390′ and is reflected as s-circular polarized first color light 1046. S-circular polarized first color light 1046 reflects from third color-selective dichroic filter 1030 changing direction of circular polarization, intercepts second reflective polarizer laminate 390′, is transmitted as p-polarized first color light 1047 which exits second PBS 400′ through fourth prism face 160′.

Reflected s-circular polarized first color light 1043 reflects from second color-selective dichroic filter 1020 changing the direction of circular polarization, and intercepts first reflective polarizer laminate 390. S-circular polarized first color light 1043 exits first reflective polarizer laminate 390 as transmitted p-polarized first color light 1044, which leaves first PBS 400 through fourth prism face 160.

The path of a second color light 1051 will now be described with reference to FIG. 10, where unpolarized second color light 1051 exits fourth prism face 160 of first PBS 400 as p-polarized second color light 1052 and fourth prism face 160′ of second PBS 400′ as p-polarized second color light 1057.

Second light source 1050 injects unpolarized second color light 1051 through second color-selective dichroic filter 1020, enters first PBS 400 through second prism face 140, intercepts first reflective polarizer laminate 390, and is split into transmitted p-polarized second color light 1052 and reflected s-circular polarized second color light 1053. Transmitted p-polarized second color light 1052 exits first PBS 400 through fourth prism face 160.

Reflected s-circular polarized second color light 1053 reflects from first color-selective dichroic filter 1010 changing direction of circular polarization, and intercepts first reflective polarizer laminate 390. S-circular polarized second color light 1053 exits first reflective polarizer laminate 390 as transmitted p-polarized second color light 1054, exits first PBS 400 through third prism face 150, enters second PBS 400′ through third prism face 150′, and intercepts second reflective polarizer laminate 390′. P-polarized second color light 1054 exits second reflective polarizer laminate 390′ as transmitted p-circular polarized second color light 1055, reflects from broadband mirror 1070 changing the direction of circular polarization, and intercepts second reflective polarizer laminate 390′. P-circular polarized second color light 1055 exits second reflective polarizer laminate 390′ as reflected s-circular polarized second color light 1056, reflects from third color-selective dichroic filter 1030 changing the direction of circular polarization, intercepts second reflective polarizer laminate 390′, exits second reflective polarizer laminate 390′ as transmitted as p-polarized second color light 1057, and exits second PBS 400′ through fourth prism face 160′ as p-polarized second color light 1057.

The path of a third color light 1061 will now be described with reference to FIG. 10, where unpolarized third color light 1061 exits fourth prism face 160 of first PBS 400 as p-polarized third color light 1067 and fourth prism face 160′ of second PBS 400′ as p-polarized third color light 1062.

Third light source 1060 injects unpolarized third color light 1061 through third color-selective dichroic filter 1030, enters second PBS 400′ through second prism face 140′, intercepts second reflective polarizer laminate 390′, and is split into transmitted p-polarized third color light 1062 and reflected s-circular polarized third color light 1063. Transmitted p-polarized third color light 1062 exits second PBS 400′ through fourth prism face 160′.

Reflected s-circular polarized third color light 1063 reflects from broadband mirror 1070 changing direction of circular polarization, and intercepts second reflective polarizer laminate 390′. S-circular polarized third color light 1063 exits second reflective polarizer laminate 390′ as transmitted p-polarized third color light 1064, exits second PBS 400′ through third prism face 150′, enters first PBS 400 through third prism face 150, and intercepts first reflective polarizer laminate 390. P- polarized third color light 1064 exits first reflective polarizer laminate 390 as transmitted p-circular polarized third color light 1065, reflects from first color-selective dichroic filter 1010 changing the direction of circular polarization, and intercepts first reflective polarizer laminate 390. P-circular polarized third color light 1065 exits first reflective polarizer laminate 390 as reflected s-circular polarized third color light 1066, reflects from second color-selective dichroic filter 1020 changing the direction of circular polarization, intercepts first reflective polarizer laminate 390, exits first reflective polarizer laminate 390 as transmitted as p-polarized third color light 1067, and exits first PBS 400 through fourth prism face 160 as p-polarized third color light 1067.

In one embodiment, first color light 1041 is blue light, second color light 1051 is red light, and third color light 1061 is green light. According to this embodiment, first color-selective dichroic filter 1010 is a red and green light reflecting and blue light transmitting dichroic filter; second color-selective dichroic filter 1020 is a green and blue light reflecting and red light transmitting dichroic filter; and third color-selective dichroic filter 1030 is a blue and red light reflecting and green light transmitting dichroic filter.

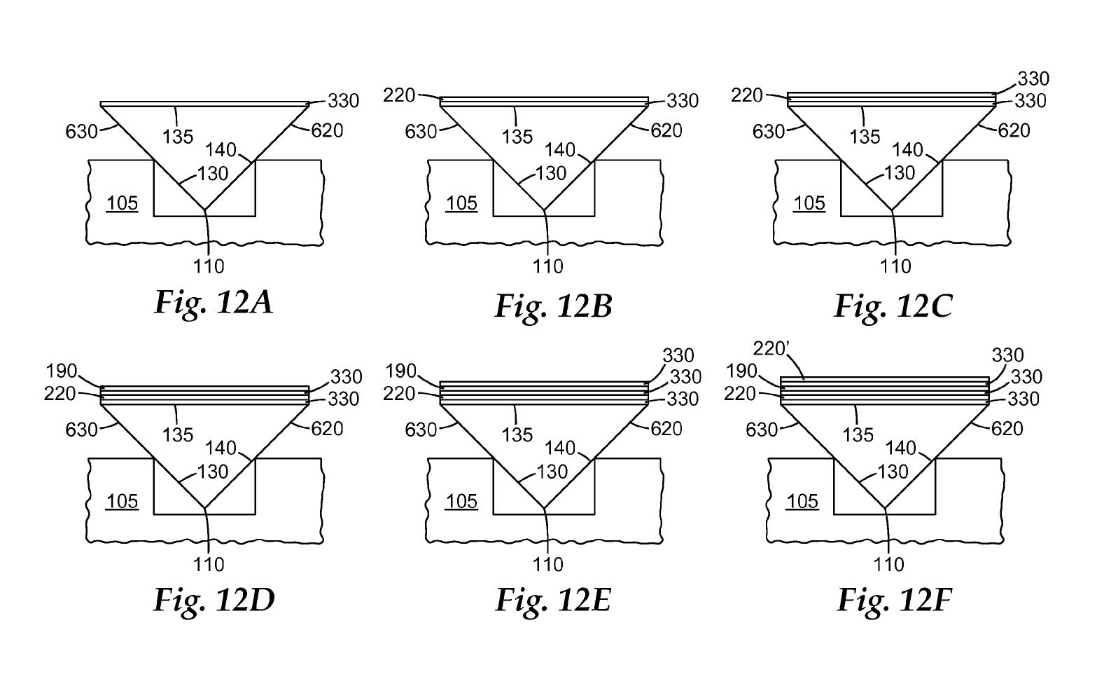

In one aspect, FIG. 11 is a top view schematic of an optical element configured as a color combiner 1100 that includes a first PBS 400 and a second PBS 400′. Color combiner 1100 can be used with a variety of light sources as described elsewhere. The paths of light rays of each polarization state emitted from a first, a second, and a third light source (1140, 1150, 1160) are shown in FIG. 11, to more clearly illustrate the function of the various components of color combiner 1100.

First PBS 400 includes a first reflective polarizer laminate 390 aligned to the first polarization state 195, disposed between the diagonal faces of first and second prisms 110, 120, as described elsewhere. Second PBS 400′ includes a second reflective polarizer laminate 390′ aligned to the first polarization state 195, disposed between the diagonal faces of first and second prisms 110′, 120′, as described elsewhere. The first and second reflective polarizer laminate (390, 390′) each include only one retarder disposed between the reflective polarizer 190 and respective first prism (110, 110′) of PBS (400, 400′), as shown in FIG. 4. A first broadband reflector 1170 is disposed adjacent second prism face 140′ of second PBS 400′, and a second broadband reflector 1180 is disposed adjacent first prism face 130′ of second PBS 400′.

A first and a second wavelength-selective filter (1110, 1120) is disposed facing the first prism face 130 of the first PBS 400. A third wavelength-selective filter 1130 is disposed facing the second prism face 140 of the first PBS 400. Each of the first, second, and third wavelength-selective filters (1110, 1120, 1130) can be a color-selective dichroic filter selected to transmit a first, a second, and a third wavelength spectrum of light, respectively, and reflect other wavelength spectrums of light. In one particular embodiment, each of the color-selective dichroic filters and the broadband mirrors can be immediately adjacent the respective prism face, such as coated directly on the prism face. In one aspect, the reflective polarizer 190 can comprise a polymeric multilayer optical film.

The color-selective dichroic filters (1110, 1120, 1130), broadband mirrors (1170, 1180), and reflective polarizer laminates 390, 390′ cooperate to transmit combined light through the fourth prism faces (160, 160′). Each unpolarized light input is split into a p-polarized and an s-circularly polarized component. The s-circularly polarized component is converted to a p-polarized component resulting in a p-polarized combined output through the fourth prism faces (160, 160′). In some cases, the nature, alignment, and efficiency of the components in the reflective polarizer laminate may result in some polarization (i.e., elliptical or circular) of the combined light, as described elsewhere. In one embodiment described below, each retarder 220 in color combiner 1100 is a quarter-wave retarder orientated at approximately 45 degrees to the first polarization state 195.

According to another aspect, an optional light tunnel 430 or assemblies of lenses (not shown) can be provided for each of the first, second, and third light sources (1140, 1150, 1160), as described elsewhere. According to another aspect, an optional integrator can be provided at the output of color combiner 1100, as described elsewhere. According to one aspect, each light source can be any of the light sources described elsewhere, for example, with reference to FIG. 6.

The path of a first color light 1141 will now be described with reference to FIG. 11, where unpolarized first color light 1141 exits fourth prism face 160 of first PBS 400 as p-polarized first color light 1144 and fourth prism face 160′ of second PBS 400′ as p-polarized first color light 1147.

First light source 1140 injects unpolarized first color light 1141 through first color-selective dichroic filter 1110, enters first PBS 400 through first prism face 130, intercepts first reflective polarizer laminate 390, and is split into transmitted p-polarized first color light 1142 and reflected s-circular polarized first color light 1143.

Transmitted p-polarized first color light 1142 exits first PBS 400 through third prism face 150, enters second PBS 400′ through third prism face 150′, intercepts second reflective polarizer laminate 390′, and is transmitted as p-circular polarized first color light 1145. P-circular polarized first color light 1145 reflects from second broadband mirror 1180 changing the direction of circular polarization, intercepts second reflective polarizer laminate 390′ and is reflected as s-circular polarized first color light 1146. S-circular polarized first color light 1146 reflects from first broadband mirror 1170 changing direction of circular polarization, intercepts second reflective polarizer laminate 390′, is transmitted as p-polarized first color light 1147 which exits second PBS 400′ through fourth prism face 160′.

Reflected s-circular polarized first color light 1143 reflects from third color-selective dichroic filter 1130 changing the direction of circular polarization, and intercepts first reflective polarizer laminate 390. S-circular polarized first color light 1143 exits first reflective polarizer laminate 390 as transmitted p-polarized first color light 1144, which leaves first PBS 400 through fourth prism face 160.

The path of a second color light 1151 will now be described with reference to FIG. 11, where unpolarized second color light 1151 exits fourth prism face 160 of first PBS 400 as p-polarized second color light 1154 and fourth prism face 160′ of second PBS 400′ as p-polarized second color light 1157.

Second light source 1150 injects unpolarized second color light 1151 through second color-selective dichroic filter 1120, enters first PBS 400 through first prism face 130, intercepts first reflective polarizer laminate 390, and is split into transmitted p-polarized second color light 1152 and reflected s-circular polarized second color light 1153.

Transmitted p-polarized second color light 1152 exits first PBS 400 through third prism face 150, enters second PBS 400′ through third prism face 150′, intercepts second reflective polarizer laminate 390′, and is transmitted as p-circular polarized second color light 1155. P-circular polarized second color light 1155 reflects from second broadband mirror 1180 changing the direction of circular polarization, intercepts second reflective polarizer laminate 390′ and is reflected as s-circular polarized second color light 1156. S-circular polarized second color light 1156 reflects from first broadband mirror 1170 changing direction of circular polarization, intercepts second reflective polarizer laminate 390′, is transmitted as p-polarized second color light 1157 which exits second PBS 400′ through fourth prism face 160′.

Reflected s-circular polarized second color light 1153 reflects from third color-selective dichroic filter 1130 changing the direction of circular polarization, and intercepts first reflective polarizer laminate 390. S-circular polarized second color light 1153 exits first reflective polarizer laminate 390 as transmitted p-polarized second color light 1154, which leaves first PBS 400 through fourth prism face 160.

The path of a third color light 1161 will now be described with reference to FIG. 11, where unpolarized third color light 1161 exits fourth prism face 160 of first PBS 400 as p-polarized third color light 1162 and fourth prism face 160′ of second PBS 400′ as p-polarized third color light 1167.

Third light source 1160 injects unpolarized third color light 1161 through third color-selective dichroic filter 1130, enters first PBS 400 through second prism face 140, intercepts first reflective polarizer laminate 390, and is split into transmitted p-polarized third color light 1162 and reflected s-circular polarized third color light 1163. Transmitted p-polarized third color light 1162 exits first PBS 400 through fourth prism face 160.

Reflected s-circular polarized third color light 1163 reflects from either first or second color-selective dichroic filter (1110, 1120) changing direction of circular polarization, and intercepts first reflective polarizer laminate 390. S-circular polarized third color light 1163 exits first reflective polarizer laminate 390 as transmitted p-polarized third color light 1164, exits first PBS 400 through third prism face 150, enters second PBS 400′ through third prism face 150′, and intercepts second reflective polarizer laminate 390′. P-polarized third color light 1164 exits second reflective polarizer laminate 390′ as transmitted p-circular polarized third color light 1165, reflects from second broadband mirror 1180 changing the direction of circular polarization, and intercepts second reflective polarizer laminate 390′. P-circular polarized third color light 1165 exits second reflective polarizer laminate 390′ as reflected s-circular polarized third color light 1166, reflects from first broadband mirror 1170 changing the direction of circular polarization, intercepts second reflective polarizer laminate 390′, exits second reflective polarizer laminate 390′ as transmitted as p-polarized third color light 1167, and exits second PBS 400′ through fourth prism face 160′ as p-polarized third color light 1167.

In one embodiment, first color light 1141 is blue light, second color light 1151 is red light, and third color light 1161 is green light. According to this embodiment, first color-selective dichroic filter 1110 is a red and green light reflecting and blue light transmitting dichroic filter; second color-selective dichroic filter 1120 is a green and blue light reflecting and red light transmitting dichroic filter; and third color-selective dichroic filter 1130 is a blue and red light reflecting and green light transmitting dichroic filter.

In some cases, less than three colors can be combined in any of the above embodiments. In this embodiment, a broadband mirror can be substituted for the color-selective dichroic filter, optional light tunnel, and light source that is removed. In some cases, a fourth color light (not shown) can also be injected into the color combiners described above. In this embodiment, a fourth color-selective dichroic filter replaces the broadband mirror (if present), an optional light tunnel, and a fourth light source can be arranged in a manner similar to the other light sources, optional light tunnels, and color-selective dichroic filters. Fourth color-selective dichroic filter reflects first, second and third color lights, and transmits fourth color light.

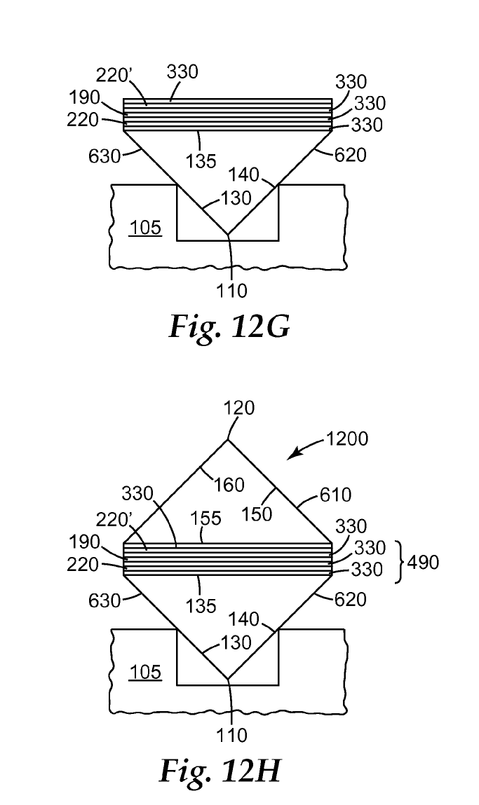

In one aspect, FIGS. 12A-12H are schematic views of a process for fabricating a PBS 1200 that includes a reflective polarizer laminate 490. FIG. 12A shows a first prism 110 supported in a fixture 105. First prism 110 includes a first prism face 130, a second prism face 140, and a first diagonal face 135 between them. A third color-selective dichroic filter 630 is coated on the first prism face 130, and a second color-selective dichroic filter 620 is coated on the second prism face 140. The second and third color selective dichroic filters 620, 630, can be coated on the respective prism faces by any means known in the art, including, for example, vacuum deposition, sputtering, solution coating, film lamination, and the like. An optical adhesive layer 330 is deposited on first diagonal face 135. The optical adhesive layer 330 can be any known optical adhesive, particularly useful optical adhesives can be those which are curable optical adhesives, such as radiation or thermally cured adhesives.

FIG. 12B shows a first retarder 220 disposed on the optical adhesive coating 330. The first retarder 220 can be any of the retarders described elsewhere, such as a quarter-wave retarder, and the slow-axis of the retarder is positioned as desired relative to the first and second prism faces 130, 140.

FIG. 12C shows an optical adhesive coating 330 disposed on the first retarder 220.

FIG. 12D shows a reflective polarizer 190 disposed on the optical adhesive coating 330. The reflective polarizer 190 can be any of the reflective polarizers described elsewhere, and the slow-axis is positioned as desired relative to the retarder 220.

FIG. 12E shows an optical adhesive coating 330 disposed on the reflective polarizer 190.

FIG. 12F shows a second retarder 220′ disposed on the optical adhesive coating. The second retarder 220′ can be any of the retarders described elsewhere, such as a quarter-wave retarder, and the slow-axis of the retarder is positioned as desired relative to the reflective polarizer 190.

FIG. 12G shows an optical adhesive 330 disposed on the second retarder 220′.

FIG. 12H shows a second prism 120 having a third prism face 150 and a fourth prism face 160, and a second diagonal face 155 between them. A first color-selective dichroic filter 610 is coated on the third prism face 150, and the second diagonal face 155 is disposed on the optical adhesive layer 330. The first color selective dichroic filters 610 can be coated on the third prism face 150 by any means known in the art, including, for example, vacuum deposition, sputtering, solution coating, film lamination, and the like. The alternating layers of optical adhesive 330, reflective polarizer 190, and retarders (220, 220′) are cured to form a PBS 1200 including a reflective polarizer laminate 490, as described elsewhere.

Light sources in a color light combining system can be energized sequentially, as described in co-pending Published U.S. Patent Application No. US 2008/0285129.According to one aspect, the time sequence is synchronized with a transmissive or reflective imaging device in a projection system that receives a combined light output from the color light combining system. According to one aspect, the time sequence is repeated at rate that is fast enough so that an appearance of flickering of projected image is avoided, and appearances of motion artifacts such as color break up in a projected video image are avoided.

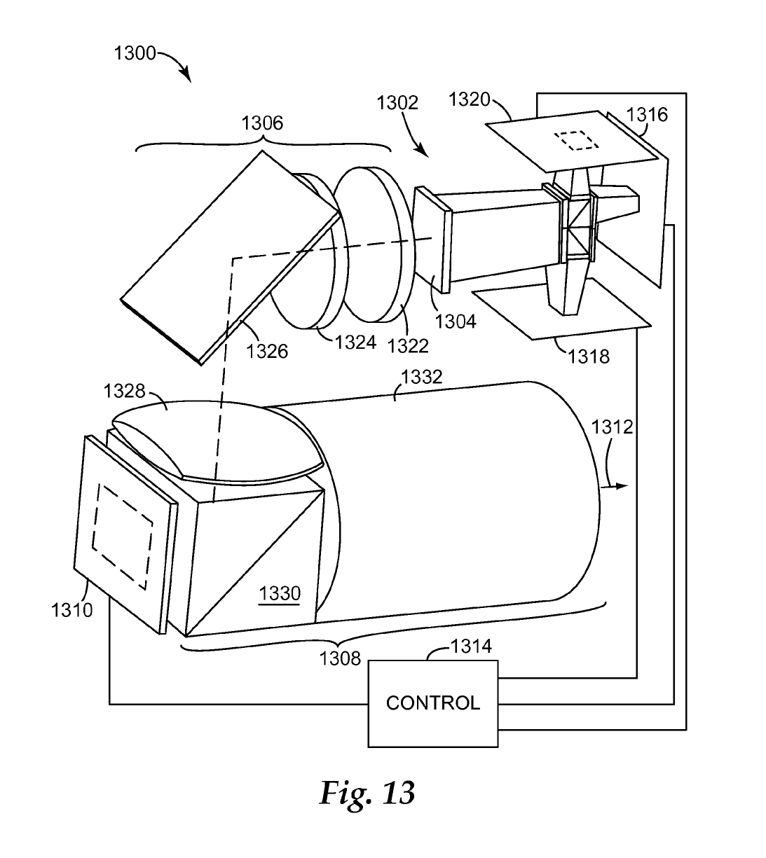

FIG. 13 illustrates a projector 1300 that includes a three color light combining system 1302. The three color light combining system 1302 provides a combined light output at output region 1304. In one embodiment, combined light output at output region 1304 is polarized. The combined light output at output region 1304 passes through light engine optics 1306 to projector optics 1308.

The light engine optics 1306 comprise lenses 1322, 1324 and a reflector 1326. The projector optics 1308 comprise a lens 1328, a PBS 1330 and projection lenses 1332. One or more of the projection lenses 1332 can be movable relative to the PBS 1330 to provide focus adjustment for a projected image 1312. A reflective imaging device 1310 modulates the polarization state of the light in the projector optics, so that the intensity of the light passing through the PBS 1330 and into the projection lens will be modulated to produce the projected image 1312. A control circuit 1314 is coupled to the reflective imaging device 1310 and to light sources 1316, 1318 and 1320 to synchronize the operation of the reflective imaging device 1310 with sequencing of the light sources 1316, 1318 and 1320. In one aspect, a first portion of the combined light at output region 1304 is directed through the projector optics 1308, and a second portion of the combined light output can be recycled back into color combiner 1302 through output region 1304. The second portion of the combined light can be recycled back into color combiner by reflection from, for example: a mirror, a reflective polarizer, a reflective LCD and the like. The arrangement illustrated in FIG. 13 is exemplary, and the light combining systems disclosed can be used with other projection systems as well. According to one alternative aspect, a transmissive imaging device can be used.

According to one aspect, a color light combining system as described above produces a three color (white) output. The system has high efficiency because polarization properties (reflection for S-polarized light and transmission for P-polarized light) of a polarizing beam splitter with reflective polarizer film have low sensitivity for a wide range of angles of incidence of source light. Additional collimation components can be used to improve collimation of the light from light sources in the color combiner. Without a certain degree of collimation, there will be significant light losses associated with variation of dichroic reflectivity as a function of angle of incidence (AOI), loss of TIR or increased evanescent coupling to frustrate the TIR, and/or degraded polarization discrimination and function in the PBS. In the present disclosure, polarizing beam splitters function as light pipes to keep light contained by total internal reflection, and released only through desired surfaces.

Although the present invention has been described with reference to preferred embodiments, workers skilled in the art will recognize that changes may be made in form and detail without departing from the spirit and scope of the invention.

Unless otherwise indicated, all numbers expressing feature sizes, amounts, and physical properties used in the specification and claims are to be understood as being modified by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

All references and publications cited herein are expressly incorporated herein by reference in their entirety into this disclosure, except to the extent they may directly contradict this disclosure. Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof

1. An optical element, comprising:
a first color-selective dichroic filter having a first input surface, disposed to transmit a first light beam perpendicular to the first input surface;
a second color-selective dichroic filter having a second input surface, disposed to transmit a second light beam perpendicular to the second input surface; and
a reflective polarizer laminate, comprising a reflective polarizer disposed between a first retarder and a second retarder,
wherein the reflective polarizer is disposed to intercept the first light beam and the second light beam at an angle of approximately 45 degrees so that the first and the second light beam are combined into a combined elliptical polarized light.

2. The optical element of claim 1, further comprising a third color-selective dichroic filter having a third input surface, disposed to transmit a third light beam perpendicular to the third input surface, wherein the reflective polarizer is disposed to intercept the first light beam, the second light beam, and the third light beam at an angle of approximately 45 degrees so that the first, the second, and the third light beam are combined into a combined elliptical polarized light.

3. The optical element of claim 1, wherein the reflective polarizer is aligned to a first polarization state and each retarder comprises approximately quarter-wave retardance aligned at an approximately 45 degree angle to the first polarization state.

4. The optical element of claim 1, further comprising a reflector disposed so that a line normal to the reflector intercepts the reflective polarizer at an angle of approximately 45 degrees.

5-7. (canceled)

8. The optical element of claim 1, further comprising a first and second prism forming a polarizing beam splitter (PBS), and wherein the reflective polarizer laminate is disposed on a first diagonal of the PBS.

9-10. (canceled)

11. An optical element, comprising:
a first color-selective dichroic filter having a first input surface, disposed to transmit a first light beam perpendicular to the first input surface;
a second color-selective dichroic filter having a second input surface, disposed to transmit a second light beam perpendicular to the second input surface;
a first reflective polarizer laminate, comprising a first reflective polarizer disposed between a first retarder and a second retarder, wherein the first reflective polarizer is disposed to intercept the first light beam and the second light beam at an angle of approximately 45 degrees;
a second reflective polarizer laminate, comprising a second reflective polarizer disposed between a third retarder and a fourth retarder, wherein the second reflective polarizer is disposed to intercept a reflected first and second light beam from the first reflective polarizer laminate at an angle of approximately 45 degrees;
a first reflector disposed so that a line normal to the first reflector intercepts the first reflective polarizer at an angle of approximately 45 degrees; and
a second reflector disposed so that a line normal to the second reflector intercepts the second reflective polarizer at an angle of approximately 45 degrees,
wherein the first and second reflective polarizer laminates and the first and second reflectors cooperate so that the first and the second light beam are combined into a combined elliptical polarized light.

12. An optical element, comprising:
a first color-selective dichroic filter having a first input surface, disposed to transmit a first light beam perpendicular to the first input surface;
a second color-selective dichroic filter having a second input surface, disposed to transmit a second light beam perpendicular to the second input surface;
a first reflective polarizer laminate, comprising a first reflective polarizer disposed between a first retarder and a second retarder, wherein the first reflective polarizer is disposed to intercept the first light beam at an angle of approximately 45 degrees;
a second reflective polarizer laminate, comprising a second reflective polarizer disposed between a third retarder and a fourth retarder, wherein the second reflective polarizer is disposed to intercept the second light beam from the first reflective polarizer laminate at an angle of approximately 45 degrees;
a first reflector disposed so that a line normal to the first reflector intercepts the first reflective polarizer at an angle of approximately 45 degrees; and
a second reflector disposed so that a line normal to the second reflector intercepts the second reflective polarizer at an angle of approximately 45 degrees,
wherein the first and second reflective polarizer laminates and the first and second reflectors cooperate so that the first and the second light beam are combined into a combined elliptical polarized light.

13. The optical element of claim 12, further comprising a third color-selective dichroic filter having a third input surface, disposed to transmit a third light beam perpendicular to the third input surface, wherein the first and second reflective polarizer laminates and the first and second reflectors cooperate so that the first, the second, and the third light beam are combined into a combined elliptical polarized light.

14. The optical element of claim 11 or claim 12, further comprising a fifth retarder capable of converting the combined elliptical polarized light into a combined linear polarized light.

15. The optical element of claim 14, wherein the fifth retarder is a quarter-wave retarder aligned at an approximately 45 degree angle to a first polarization state.

16. An optical element, comprising:
a first color-selective dichroic filter having a first input surface, disposed to transmit a first light beam perpendicular to the first input surface;
a second color-selective dichroic filter having a second input surface, disposed to transmit a second light beam perpendicular to the second input surface;
a first reflective polarizer laminate, comprising a first reflective polarizer disposed adjacent to a first retarder, wherein the first retarder is disposed to intercept the first light beam and the second light beam at an angle of approximately 45 degrees;
a second reflective polarizer laminate, comprising a second reflective polarizer disposed adjacent to a second retarder, wherein the second retarder is disposed to intercept a reflected first and second light beam from the first reflective polarizer laminate at an angle of approximately 45 degrees; and
a half-wave retarder disposed between the first retarder and the second retarder,
wherein the first and second reflective polarizer laminates and the half-wave retarder cooperate so that the first and the second light beam are combined into a combined linear polarized light having a first polarization state.

17. An optical element, comprising:
a first color-selective dichroic filter having a first input surface, disposed to transmit a first light beam perpendicular to the first input surface;
a second color-selective dichroic filter having a second input surface, disposed to transmit a second light beam perpendicular to the second input surface;
a first reflective polarizer laminate, comprising a first reflective polarizer disposed adjacent to a first retarder, wherein the first retarder is disposed to intercept the first light beam at an angle of approximately 45 degrees;
a second reflective polarizer laminate, comprising a second reflective polarizer disposed adjacent to a second retarder, wherein the second retarder is disposed to intercept the second light beam at an angle of approximately 45 degrees; and
a half-wave retarder disposed between the first retarder and the second retarder,
wherein the first and second reflective polarizer laminates and the half-wave retarder cooperate so that the first and the second light beam are combined into a combined linear polarized light having a first polarization state.

18. The optical element of claim 17, further comprising a third color-selective dichroic filter having a third input surface, disposed to transmit a third light beam perpendicular to the third input surface, wherein the first and second reflective polarizer laminates and the half-wave retarder cooperate so that the first, the second, and the third light beam are combined into a combined linear polarized light having a first polarization state.

19. An optical element, comprising:
a first color-selective dichroic filter having a first input surface, disposed to transmit a first light beam perpendicular to the first input surface;
a second color-selective dichroic filter having a second input surface, disposed to transmit a second light beam perpendicular to the second input surface;
a first reflective polarizer laminate, comprising a first reflective polarizer disposed adjacent a first retarder, wherein the first retarder is disposed to intercept the first light beam and the second light beam at an angle of approximately 45 degrees;
a second reflective polarizer laminate, comprising a second reflective polarizer disposed adjacent to a second retarder, wherein the second retarder is disposed to intercept a transmitted first light beam and second light beam from the first reflective polarizer laminate at an angle of approximately 45 degrees; and
a reflector disposed so that a line normal to the reflector intercepts the second reflective polarizer at an angle of approximately 45 degrees,
wherein the first and second reflective polarizer laminates and the reflector cooperate so that the first and the second light beam are combined into a combined linear polarized light having a first polarization state.

20. An optical element, comprising:
a first color-selective dichroic filter having a first input surface, disposed to transmit a first light beam perpendicular to the first input surface;
a second color-selective dichroic filter having a second input surface, disposed to transmit a second light beam perpendicular to the second input surface;
a first reflective polarizer laminate, comprising a first reflective polarizer disposed adjacent a first retarder, wherein the first retarder is disposed to intercept the first light beam and the second light beam at an angle of approximately 45 degrees;
a second reflective polarizer laminate, comprising a second reflective polarizer disposed adjacent to a second retarder, wherein the second retarder is disposed to intercept a second light beam at an angle of approximately 45 degrees; and
a reflector disposed so that a line normal to the reflector intercepts the second reflective polarizer at an angle of approximately 45 degrees,
wherein the first and second reflective polarizer laminates and the reflector cooperate so that the first and the second light beam are combined into a combined linear polarized light having a first polarization state.

21. The optical element of claim 19 or claim 20, further comprising a third color-selective dichroic filter having a third input surface, disposed to transmit a third light beam perpendicular to the third input surface, wherein the first and second reflective polarizer laminates and the reflector cooperate so that the first, the second, and the third light beam are combined into a combined linear polarized light having a first polarization state.

22. An optical element, comprising:
a first color-selective dichroic filter having a first input surface, disposed to transmit a first light beam perpendicular to the first input surface;
a second color-selective dichroic filter having a second input surface, disposed to transmit a second light beam perpendicular to the second input surface;
a first reflective polarizer laminate, comprising a first reflective polarizer disposed adjacent to a first retarder, wherein the first retarder is disposed to intercept the first light beam and the second light beam at an angle of approximately 45 degrees;
a second reflective polarizer laminate, comprising a second reflective polarizer disposed adjacent a second retarder, wherein the second reflective polarizer is disposed to intercept a transmitted first linear polarization state of the first and the second third light beams at an angle of approximately 45 degrees;
a first reflector disposed so that a line normal to the first reflector intercepts the second reflective polarizer laminate at an angle of approximately 45 degrees; and
a second reflector disposed so that a line normal to the second reflector intercepts the second reflective polarizer laminate at an angle of approximately 45 degrees,
wherein the first and second reflective polarizer laminates and the first and second reflectors cooperate so that the first and the second light beams are combined into a combined linear polarized light having the first polarization state.

23. An optical element, comprising:
a first color-selective dichroic filter having a first input surface, disposed to transmit a first light beam perpendicular to the first input surface;
a second color-selective dichroic filter having a second input surface, disposed to transmit a second light beam perpendicular to the second input surface;
a first reflective polarizer laminate, comprising a first reflective polarizer disposed adjacent to a first retarder, wherein the first retarder is disposed to intercept the first light beam and the second light beam at an angle of approximately 45 degrees;
a second reflective polarizer laminate, comprising a second reflective polarizer disposed adjacent a second retarder, wherein the second reflective polarizer is disposed to intercept a transmitted first linear polarization state of the first light beam at an angle of approximately 45 degrees;
a first reflector disposed so that a line normal to the first reflector intercepts the second reflective polarizer laminate at an angle of approximately 45 degrees; and
a second reflector disposed so that a line normal to the second reflector intercepts the second reflective polarizer laminate at an angle of approximately 45 degrees,
wherein the first and second reflective polarizer laminates and the first and second reflectors cooperate so that the first and the second light beams are combined into a combined linear polarized light having the first polarization state.

24. The optical element of claim 23, further comprising a third color-selective dichroic filter having a third input surface, disposed to transmit a third light beam perpendicular to the third input surface, wherein the first and second reflective polarizer laminates and the first and second reflectors cooperate so that the first, the second, and the third light beams are combined into a combined linear polarized light having the first polarization state.

25-35. (canceled)
